(19) United States
(12) Patent Application Publication
(10) Pub. No.: US 2024/0126341 A1
(43) Pub. Date: Apr. 18, 2024

(54) Edge rib and laser etching treatment to improve waterproofing of smart ring

(71) Applicant: Plume Design, Inc., Palo Alto, CA (US)

(72) Inventors: Ming-Tsung Su, Taipei City (TW); Hao-Hsiu Huang, Taipei City (TW); Chun Hung Liu, Taipei City (TW)

(21) Appl. No.: 18/105,441

(22) Filed: Feb. 3, 2023

Related U.S. Application Data
(63) Continuation-in-part of application No. 17/965,985, filed on Oct. 14, 2022.

(51) Int. Cl. G06F 1/16; B23K 26/362

(52) U.S. Cl. CPC G06F 1/1656; B23K 26/362; G06F 1/163; B23K 2101/30

(57) ABSTRACT

Smart rings and methods of manufacturing smart rings are provided. A waterproof design and method of manufacturing of a smart ring, in accordance with one implementation, includes a band having at least an outer surface and an inner surface. The inner surface of the band includes features configured to support electronic components. The waterproofing design and method of manufacturing includes a laser etching a portion of the inner surface and subsequent to the laser etching of the portion, applying an epoxy over the electronic components and over the laser etched portion of the inner surface. Prior to the laser etching, forming an edge rib on the portion of the inner surface, wherein the laser etching is subsequently on the edge rib. Furthermore, the laser etched portion includes an increased contact area for bonding with the epoxy for the waterproof design.

### CROSS-REFERENCE TO RELATED APPLICATIONS

The present disclosure is a continuation-in-part of U.S. patent application Ser. No. 17/965,985, filed Oct. 14, 2022, the contents of which are incorporated by reference in their entirety.

### FIELD OF THE DISCLOSURE

The present disclosure generally relates to wearable smart rings having sensors and communication circuitry. More particularly, the present disclosure relates to the process of adding an edge rib feature which includes a laser etching treatment on the edge rib of the smart ring in order to improve waterproofing.

### BACKGROUND OF THE DISCLOSURE

Generally, over time, engineering designs of many types of electronic devices continues to produce smaller and smaller sizes of devices. With the possibility of such small form factors, one area that has been developed in recent years has been the wearable smart ring. Smart rings are electronics device that can be worn on a user's finger and may include various types of sensors, such as heart rate sensors, blood oxygen sensors, glucose sensors, among others. The data obtained from these smart ring sensors can then be used in a number of different types of applications (e.g., fitness tracking apps, health management apps, sleep monitoring apps, etc.). Also, smart rings may include other types of electronics, such as Near Field Communication (NFC) chips, access control devices, and other devices built into their relatively small casing.

Smart rings typically have a basic structure and are usually more utilitarian than stylish. Also, adding decorative elements to improve the aesthetics of smart rings can cause issues. For example, by incorporating a decorative element onto a smart ring, a manufacturer may experience problems when it comes to polishing various surfaces of the ring, which is one reason why many manufacturers typically resort to providing only simple designs. Nevertheless, in order to allow smart rings to include more decorative aspects, there is a need to address the issue of manufacturing these smart rings so as to maintain functionality while also offering styles that are aesthetically appealing.

Wearable devices such as a necklace, lanyard, strap, pendant, smart glasses, smart watch, which can be worn or carried by a user benefit greatly from having a level of water resistance or water proofing. This is especially true with smart rings as users want to be able to perform daily activities without having to take off the ring such as washing hands, showering, or swimming. Waterproofing an electronic device includes testing the water resistance at certain atmospheres (atm) to determine the amount of pressure the device can withstand without damage and water intrusion. 5 atm water resistant or waterproofing means that the device can withstand pressures equivalent to about 50 meters or 164 feet under water for 10 minutes. A 5 atm rating typically allows the device to be worn while swimming for brief periods of time, in the shower, or in the rain.

### BRIEF SUMMARY OF THE DISCLOSURE

The present disclosure relates to smart rings, bands or foundation components that form the physical backbone of many of these smart rings, and manufacturing processes for creating these smart rings. In one implementation, a foundation component of a smart ring includes a band having at least an outer surface and an inner surface. The inner surface includes features configured to support electronic components. The foundation component also includes a decorative element having a bottom surface that has a shape substantially corresponding to at least a portion of the outer surface of the band. The decorative element is attached to the outer surface of the band.

The decorative element may be attached to the outer surface of the band by a laser welding technique. For example, the laser welding technique may include spot welding in a mosaic pattern on the inner surface of the band. A manufacturing process may include a pre-treatment process on the outer surface of the band, which may be performed before the decorative element is attached the band. The pre-treatment process, for example, may include at least a polishing step.

At least a portion of the outer surface of the band may include a substantially cylindrical shape. Also, the outer surface of the band may include a locating feature configured to allow the decorative element to be positioned at a specific location on the outer surface of the band. In some embodiments, the decorative element is a logo. The band and the decorative element may include the same material. The band and/or decorative element may be machined using a Computer Numerical Control (CNC) technique and/or a Computer-Aided Manufacturing (CAM) technique.

In some implementations, smart rings may be formed from this foundation component. The smart ring may further include electronic components supported on the inner surface of the band. The electronic components may include at least a low-profile battery and a low-profile Flexible Printed Circuit (FPC) configured for wireless communication with a secondary device. At least a portion of the low-profile battery may be arranged at a position on the inner surface of the band near a location of the decorative element. At least a portion of the low-profile FPC may be arranged at an opposite end of the band. The electronic components may further include a Near Field Communication (NFC) device for charging the low-profile battery.

In one implementation, a foundation component of a smart ring may include a band having at least an outer surface and an inner surface, where the inner surface may include features configured to support electronic components. Furthermore, subsequent to including the electronic components within the inner surface a method of manufacturing for laser etching a portion of the inner surface and subsequent to laser etching of the portion applying an epoxy over the electronic components and over the laser etched portion of the inner surface. The laser etching is implemented on an edge rib located on the inner surface of the band and wherein the edge rib physically extends outward from the inner surface in the same direction as the electronic components. The laser etching on the edge rib increases the contact area for bonding with the epoxy and improves the waterproof design of the smart ring.

### BRIEF DESCRIPTION OF THE DRAWINGS

The present disclosure is illustrated and described herein with reference to the various drawings, in which like reference numbers are used to denote like system components/method steps, as appropriate, and in which:

FIGS. 1A-1C are diagrams illustrating different views of a smart ring having wireless-communication capabilities for communicating with other electronic devices, according to various embodiments.

FIGS. 2A and 2B are diagrams illustrating exploded views of two different ring sizes of the smart ring of FIG. 1, according to various embodiments.

FIG. 3 is a diagram illustrating a foundation component of the smart ring of FIG. 1, according to various embodiments.

FIG. 4 is a diagram illustrating a circular element of the foundation component of FIG. 3, according to various embodiments.

FIG. 5 is a diagram illustrating a decorative element of the foundation component of FIG. 3, according to various embodiments.

FIG. 6 is a diagram illustrating an inside portion of the foundation component of FIG. 3 with the decorative element of FIG. 5 laser welded on the circular element of FIG. 4, according to various embodiments.

FIGS. 7A and 7B are diagrams illustrating assembly steps for installing a ferrite sheet to an inside surface of the band of FIG. 4, according to various embodiments.

FIGS. 8A and 8B are diagrams illustrating assembly steps for installing battery tape to an inside surface of the band of FIG. 4, according to various embodiments.

FIGS. 9A-9E are diagrams illustrating assembly steps for forming a groove or pouch at one end of a low-profile battery, according to various embodiments.

FIGS. 10A-10D are diagrams illustrating assembly steps for installing a metal clip into the groove or pouch in the low-profile battery of FIG. 9, according to various embodiments.

FIGS. 11A-11D are diagrams illustrating assembly steps of soldering the metal clip of FIG. 10 in the groove or pouch in the low-profile battery of FIG. 9, according to various embodiments.

FIGS. 12A-12D are diagrams illustrating assembly steps for dispensing glue into the groove or pouch in the low-profile battery of FIG. 9, according to various embodiments.

FIGS. 13A-13C are diagrams illustrating assembly steps for installing a Flexible Printed Circuit (FPC) onto FPC tape, according to various embodiments.

FIGS. 14A-14F are diagrams illustrating assembly steps of installing the low-profile battery of FIG. 9 onto the inside surface of the band of FIG. 4, according to various embodiments.

FIGS. 15A-15D are diagrams illustrating assembly steps for pre-bending terminal wires of the low-profile battery of FIG. 9, according to various embodiments.

FIGS. 16A and 16B are diagrams illustrating assembly steps for dispensing glue onto the inside surface of the band of FIG. 4 for installing the FPC, according to various embodiments.

FIGS. 17A-17E are diagrams illustrating assembly steps for installing the FPC onto the inside surface of the band of FIG. 4, according to various embodiments.

FIGS. 18A-18D are diagrams illustrating assembly steps for installing gap fillers on the inside surface of the band of FIG. 4 for smart rings having different ring sizes, according to various embodiments.

FIGS. 19A-19C are diagrams illustrating assembly steps for bending the terminal wires of the low-profile battery for contacting corresponding pads on the FPC, according to various embodiments.

FIGS. 20A and 20B are diagrams illustrating assembly steps for checking the position of a heart rate sensor with respect to the band of FIG. 4, according to various embodiments.

FIGS. 21A and 21B are diagrams illustrating assembly steps for attaching a Bluetooth antenna to a pad of the FPC, according to various embodiments.

FIGS. 22A-22C are diagrams illustrating assembly steps for installing a ferrite sheet to the battery, according to various embodiments.

FIGS. 23A-23E are diagrams illustrating assembly steps for attaching a Near Field Communication (NFC) component onto an inside portion of the band of FIG. 4, according to various embodiments.

FIGS. 24A-24G are diagrams illustrating assembly steps for molding an epoxy over the electrical components on the inside surface of the band of FIG. 4 to complete a sub-assembly of the smart ring, according to various embodiments.

FIGS. 25A-25G are diagrams illustrating assembly steps for gluing and buffing the sub-assembly of the smart ring, according to various embodiments.

FIGS. 26A-26C are diagrams illustrating assembly steps for checking sidewall thickness of the smart ring, according to various embodiments.

FIG. 27 is a diagram illustrating electrical components of the smart ring of FIG. 1 configured to wirelessly communicate with a secondary electronic device, according to various embodiments.

FIG. 28 is a flow diagram illustrating a process for manufacturing the smart ring of FIG. 1, according to various embodiments.

FIG. 29A-29C are diagrams and section views illustrating details for the existing industry waterproofing design and manufacturing processes.

FIG. 30A-30E are diagrams and section views illustrating details for the improved waterproofing design and manufacturing processes according to various embodiments.

### DETAILED DESCRIPTION OF THE DISCLOSURE

The embodiments of present disclosure are directed to smart rings and the design and manufacturing of these smart rings. The present disclosure is also directed to the underlying foundations of these smart rings, which may be referred to herein as bands or foundation components. According to the embodiments of the present disclosure, manufacturing processes may include attaching (e.g., laser welding) any decorative elements onto this band or foundation component after the band and decorative elements are pre-treated (e.g., polished) to allow the treatment on all surfaces. Otherwise, if the decorative element and band of a ring are formed together in one step, it can be difficult to treat certain surfaces, such as the corners where the decorative element meets the band, which may result in a less than ideal appearance. Therefore, a manufacturing technique may include 1) form a decorative element and band in separate molds, 2) pre-treat (e.g., clean, polish, etc.) the decorative element and band separately, 3) attach the decorative element to the band, 4) assemble the electronic components onto the band, and 5) apply epoxy to cover the electronic components. In this way, a smart ring may be formed with more aesthetic designs. The manufacturing process to achieve an optimized waterproof design for the smart ring includes laser etching a portion of the inner surface and subsequent to the laser etching of the portion applying an epoxy over the electronic components and over the laser etched portion of the inner surface. The laser etched portion provides an increased contact area for bonding with the epoxy and reduces the probability of water int

In one implementation, a foundation component of a smart ring may include a band having at least an outer surface and an inner surface, where the inner surface may include features configured to support electronic components. Furthermore, subsequent to including the electronic components within the inner surface a method of manufacturing for laser etching a portion of the inner surface and subsequent to laser etching of the portion applying an epoxy over the electronic components and over the laser etched portion of the inner surface. The laser etching is implemented on an edge rib located on the inner surface of the band and wherein the edge rib physically extends outward from the inner surface in the same direction as the electronic components. The laser etching on the edge rib provides an abrasive surface which increases the contact area for bonding with the epoxy glue, and the edge rib provides a barrier for water intrusion. The better adhesion from the laser etching and the water barrier formed by the edge rib improve the water proofing of the smart ring and allow the ring to be tested and rated for 5 atm.

### Smart Ring

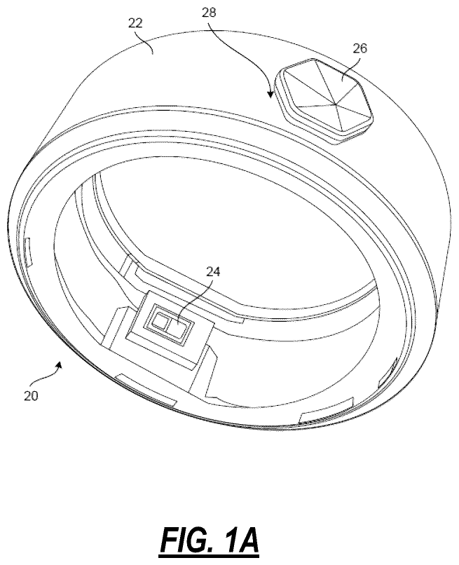

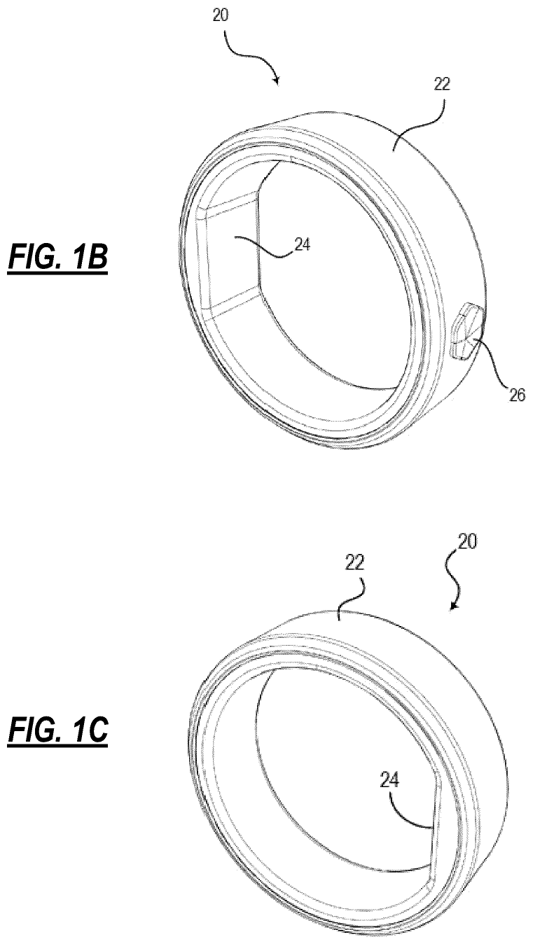

FIGS. 1A-1C show different perspective views of an embodiment of a smart ring 20 having wireless-communication capabilities for communicating with other electronic devices. In general, the smart ring 20 includes a band 22 having a width expanded portion 24 and a decorative element 26 (e.g., logo, emblem, crest, symbol, etc.). The band 22 may have any suitable size that can fit around a user's finger (or which can be worn on a thumb, toe, inserted on a necklace or chain, etc.). In some embodiments, different processes may be used to form the band 22 to conform with specifically known ring sizes, such as, for example, sizes 6-14.

In this embodiment, the width expanded portion 24 is configured to fill in a small portion of an inner space formed by the band 22. The width expanded portion 24 may have a substantially planar surface that faces this middle area. For example, the width expanded portion 24 may be helpful for keeping the smart ring 20 in a set orientation around the user's finger, such that the decorative element 26 is pointed generally outward from the user's hand. Also, this orientation can be useful with respect to the locations of sensors in the smart ring 20 and how they detect certain parameters.

According to some embodiments, the decorative element 26 may be created by a separate manufacture process from the band 22 and may then be attached to an outer surface of the band 22. That is, after forming the band 22 and decorative element 26 in different steps, the decorative element 26 may then be attached to the band 22. For example, the decorative element 26 may be laser welded to the band 22 by a laser welding process that involves focusing laser beams on an inside surface of the band 22. More particularly, and as described in more detail below, the band 22 may include a base element onto which the decorative element 26 is attached. This attachment step may be performed prior to connecting electronic components to the base element for forming the band 22 as shown in FIG. 1. Also, in other various embodiments, the decorative element 26 may include functional elements as well, such as a camera, microphone, speaker, etc.

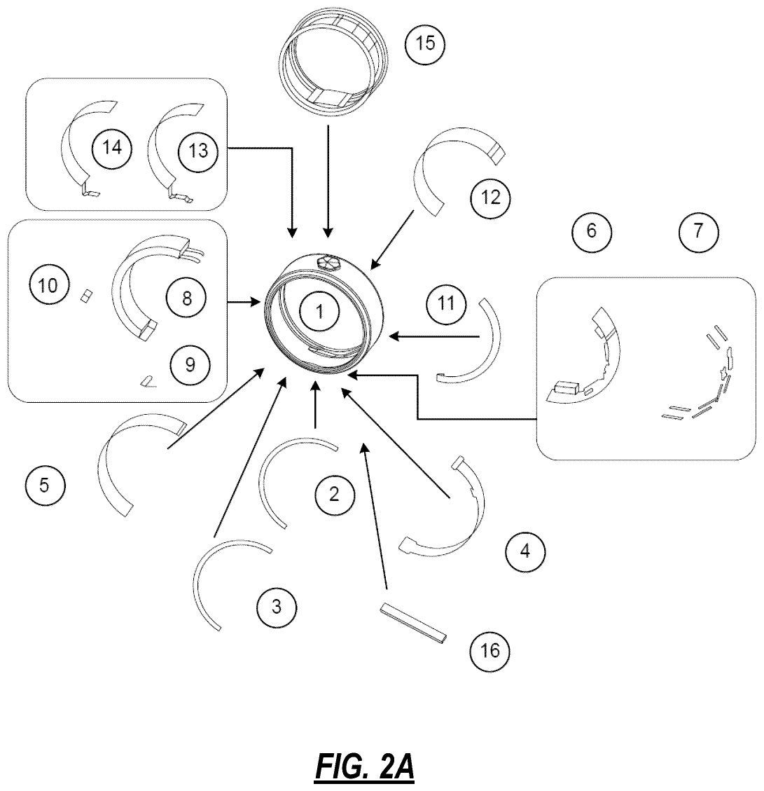

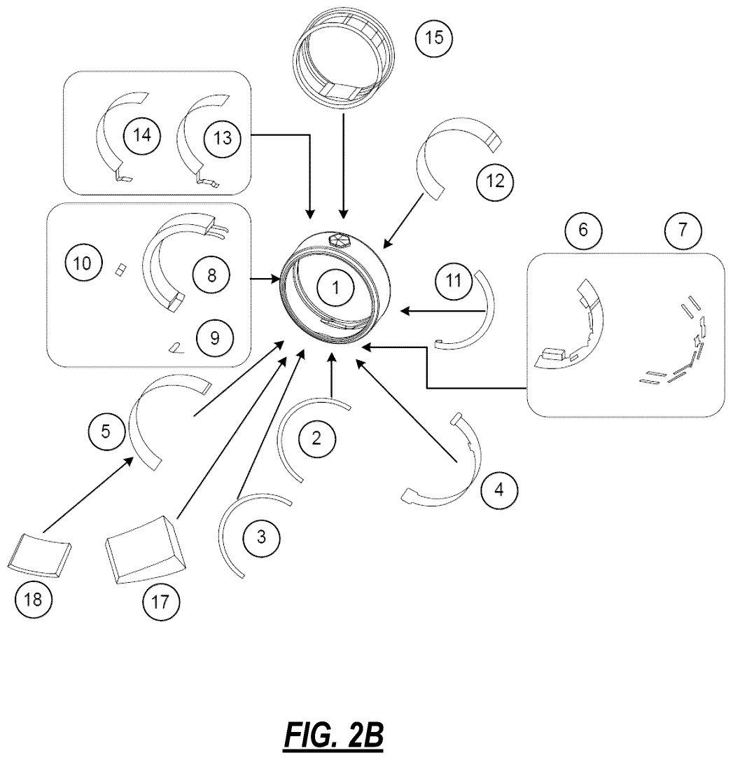

In particular, one of the reasons that the band 22 and the decorative element 26 may be created in separate steps is for aesthetic purposes. For example, if the two elements were formed together as one part, a polishing step (or other type of treatment process) may have difficulty reaching areas 28 (e.g., inside corners) at the base of the decorative element 28. For example, the areas 28 may include portions of the band 22 near the location of the decorative element 26 as well as the base portions of the decorative element 26 itself. If the entire band 22 can be polished sufficiently except for the areas 28 around the decorative element 26, the smart ring 20 may not have as pleasing of an appearance as might be expected. Thus, by manufacturing the smart ring 20 such that the band 22 and decorative element 26 are formed separately, the band 22 can be treated (e.g., polished) uniformly and consistently around the entire outer surface thereof and the decorative element 26 can also be uniformly and consistently treated. Then, the decorative element 26 can be attached (e.g., laser welded) to the band 22 to create an aesthetically pleasing look. Thereafter, other assembly steps can be performed (e.g., as described with respect to FIGS. 2-26) to connect electronic elements to an inside surface of the band 22 for completing the smart ring 20 to the product shown in FIG. 1.

In some embodiments, the smart ring 20 and decorative element 26 may include titanium or include a titanium finish, which has many desirable features (e.g., lightweight, strong, potentially slim profile, etc.). Also, the completed smart ring 20 may be water resistant and may have a rechargeable battery. In some embodiments, the smart ring 20 may include various sensors, such as a 14-bit Photoplethysmography (PPG) sensor, an accelerometer (e.g., three-axis accelerometer), etc. The smart ring 20 can be configured to measure vitals, such as heart rate, heart rate variability, sleep patterns, activity levels, fall events, and the like.

The smart ring 20 may be configured to wirelessly communicate at short range to various devices, such as a control device incorporated in a local network (e.g., Wi-Fi network). The control device, in some embodiments, may be a stand-alone device, an access point device of a Wi-Fi system, a modem, a switch, a network node, a gateway device, a Bluetooth beacon device, a hub device, a mobile phone, etc. For example, when positioned near such a control device, the smart ring 20 and control device may be configured to operate within a first frequency band (e.g., Bluetooth frequencies) to enable communication therebetween. In response to receiving control commands and/or movement information from the smart ring 20, the control device may be configured to control one or more electrical devices in the local network or within a certain setting or periphery.

FIGS. 2A and 2B are diagrams illustrating exploded views of embodiments of two different ring sizes of the smart ring 20 of FIG. 1. For example, FIG. 2A may represent the elements used for creating the smart ring 20 when the smart ring 20 is configured to have a ring size within the range of ring sizes 6-9. Also, FIG. 2B may represent the elements used for creating the smart ring 20 when the smart ring 20 is configured to have a ring size within the range of rings sizes 10-14. One of ordinary skill will understand that these specific ring sizes and modifications to the smart ring 20 to accommodate different sizes are for illustrative purposes only and are not intended to limit the scope of the present disclosure since the present disclosure is meant to include all reasonable modifications that can be conceived from an understanding of the embodiments discussed herein. Furthermore, although two different embodiments are shown with respect to FIGS. 2A and 2B, it should also be noted that more than two different designs may be conceived for forming any number of different ranges of ring sizes.

In particular, the parts of the smaller ring (i.e., FIG. 2A) and the larger ring (i.e., FIG. 2B) have many similarity and may only differ with respect to size. Also, it may be noted that filler elements (e.g., parts 16, 17, 18) may differ depending on the ring size. The parts of the smart ring 20 includes:
1—foundation component
2—back sidewall
3—front sidewall
4—ferrite sheet
5—battery tape
6—Flexible Printed Circuit (FPC)
7—FPC tape
8—battery
9—metal clip
10—battery glue
11—FPC glue
12—ferrite sheet
13—Near Field Communication (NFC) device
14—NFC tape
15—inner epoxy
16—small gap filler (FIG. 2A)
17—first large gap filler (FIG. 2B)
18—second large gap filler (FIG. 2B)

### Laser Welding Before Assembly

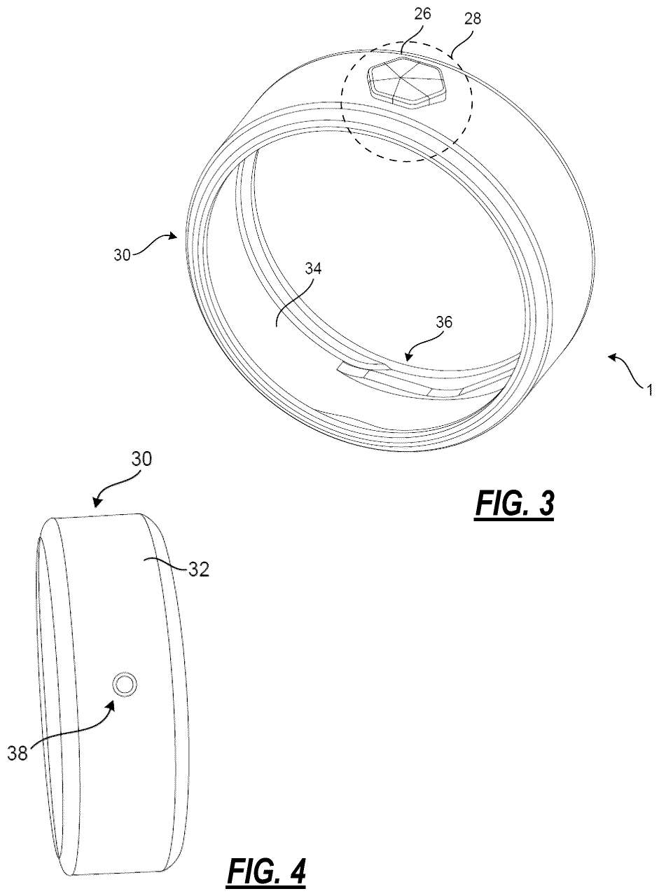

FIG. 3 is a diagram illustrating an embodiment of the foundation component 1 of the smart ring 22. The foundation component 1 includes a circular element 30 (e.g., band) and the decorative element 26 (e.g., as described above with respect to FIG. 1). As illustrated in FIG. 3, the decorative element 26 is already attached to the circular element 30. Again, the area 28 around the location where the decorative element 26 is attached to the circular element 30 may be pre-treated (e.g., polished) before the attachment process. The decorative element 26 may have a bottom surface (not shown) that substantially corresponds to the shape of the outer surface 32 of the foundation component 1.

An outer surface 32 of the circular element 30 forms the outside surface of the smart ring 20. Also, an inner surface 34 of the circular element 30 includes features 36 (e.g., edges, ridges, protrusions, etc.) that allow electronic components (e.g., FPC 6, battery 8, NFC device 13, etc.) to be connected to the inner surface 34.

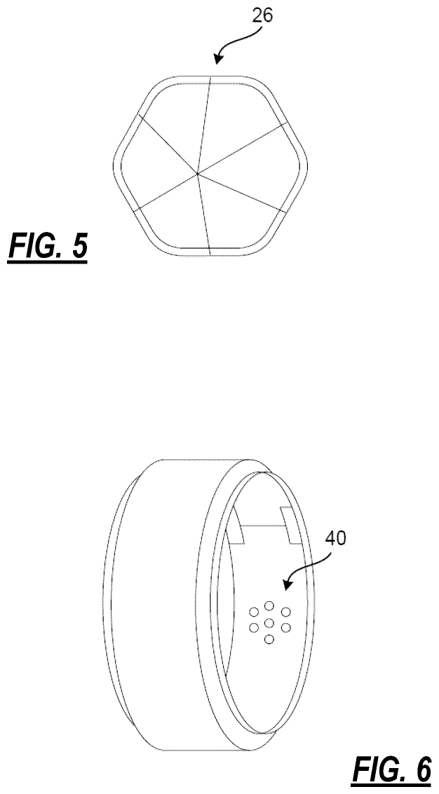

FIG. 4 is a diagram illustrating an embodiment of the circular element 30 of the foundation component 1. FIG. 5 is a diagram illustrating an embodiment of the decorative element 26. In particular, the circular element 30 may include a locating feature 38 formed on the outer surface 32 thereof. The locating feature 38 is configured to allow the decorative element 26 to be positioned on the outer surface 32 at a predetermined location. In some embodiments, a bottom portion of the decorative element 26 may include features (not shown) that correspond to the locating feature 38 to position the decorative element 26 at the predetermined location. Also, the corresponding features may be used for positioning the decorative element 26 in a specific orientation (e.g., where edges of the decorative element 26 are substantially parallel with the edges of the circular element 30.

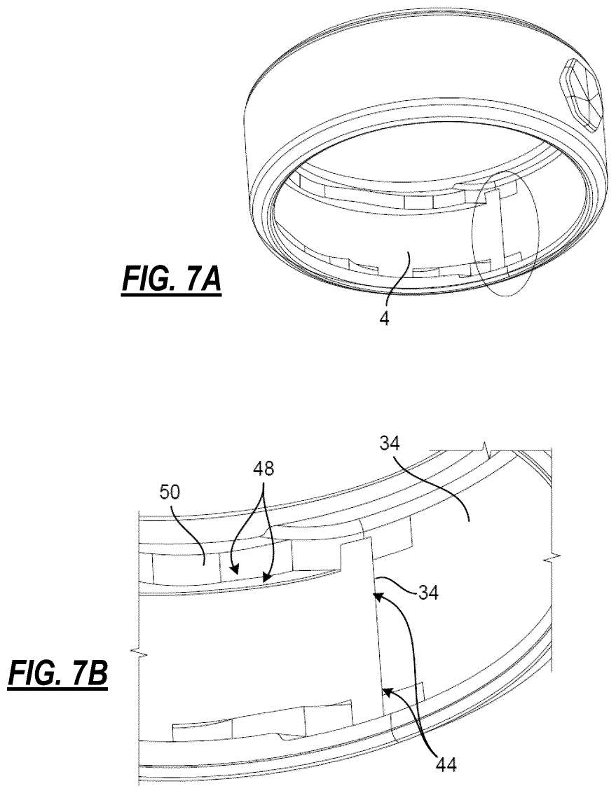

FIG. 6 is a diagram illustrating the inner surface 34 of the circular element 30 of the foundation component 1. More particularly, FIG. 6 shows laser spots 40 on the inner surface 34 formed during a laser welding process involving the step of focusing laser beams on the inner surface 34 to weld the decorative element 26 onto the outer surface 32 of the foundation component 1. In some embodiments, the laser spots 40 may be created in such a way that forms a mosaic pattern. It should be noted, as will be more easily understood from the description of FIGS. 7-26, that the inner surface 34 will be covered by electronic components and other elements during the manufacturing procedures of the present disclosure and will not be seen from the final product of the smart ring 20 as shown in FIG. 1.

Therefore, the present disclosure is directed to smart rings, the manufacturing of smart rings, the manufacturing process of attaching a decorative element to an outer surface of a circular element (or band) of the smart ring before other assembly steps, and other related systems and methods. A smart ring (e.g., smart ring 20), according to one implementation, may include the band 22 (e.g., shank, base, main body, etc.) having at least the outer surface 32. At least a portion of the outer surface 32 may have a substantially cylindrical shape. The outer surface 32 is configured to be exposed when the ring is worn on a user's finger. The band 22 (e.g., foundation component 1, circular element 30) also includes the inner surface 34, which may include features 36 configured to support electronic components. Furthermore, the smart ring 20 may also include the decorative element 26 having a bottom surface substantially corresponding to the shape of the outer surface 32 of the band 22. The decorative element 26 is laser welded (e.g., using Laser Beam Welding (LBW)) onto the outer surface 32 of the band 22.

Furthermore, the smart ring 20 (and the manufacturing of such) may further include additional features. For example, the entire outer surface 32 of the circular element 30 may treated or pre-treated (e.g., polishing, cleaning, forming, etc.) in a uniform manner before the process of welding the decorative element 26 onto the circular element 30. The substantially cylindrical outer surface 32 and the bottom surface of the decorative element 26 may have corresponding placement features (e.g., attachment positioning features, locating features, alignment connection or attachment features, etc.) to allow the decorative element 26 to be positioned at a specific location on (and in a specific orientation with respect to) the outer surface 32 of the circular element 30. For example, the placement feature (e.g., locating feature 38) of the outer surface 32 may be an indentation, recess, notch, space, hole, cavity, pit, etc. The placement feature of the decorative element 26 may be a protrusion, projection, peg, plug, pin, jut, etc.

In some embodiments, the laser welding process may include spot welding where the decorative element 26 and the circular element 30 are welded with the laser spots 40 in a mosaic pattern on the inner surface 34 of the band circular element 30. One or both of the band 22 and decorative element 26 may be machined using Computer Numerical Control (CNC) and/or Computer-Aided Manufacturing (CAM) techniques.

Also, the circular element 30 (and/or the outer surface 32 of the band 20) and the decorative element 26 may include the same material (e.g., titanium). In some embodiments, the decorative element 26 may have a color that is different from a predominate color of the band 22.

Furthermore, the inner surface 34 of the circular element 30 may include features 36 configured to support electronic components. For example, these electronic components may include at least a low-profile battery (e.g., battery 8) and a low-profile FPC (e.g., FPC 6), which may be used for wireless communication with an external electrical device. In some embodiments, about half of the inner surface 34 of the smart ring 20 may include the battery 8 and about the other half may include the FPC 6. At least a portion of the battery 8 may be arranged at a position on the inner surface 34 of the band 22 near the decorative element 26, while the FPC 6 may be arranged on the opposite end of the band 22. In some embodiments, the NFC device 13 may be used for charging the battery 8. The battery tape 5 and/or battery glue 10 may be used for connecting the battery 8 to the inner surface 34 of the circular element 30. The FPC tape 7 and/or FPC glue 11 may be used for connecting the FPC 6 to the inner surface 34 to increase the bonding.

In some embodiments, the smart ring 20 may be formed where the inner surface 34 of the circular element 30 has one or more laser etching lines for aligning the electronic components during assembly. The assembly process may include using an alignment fixture (or assembly fixture) for aligning the battery 8 on the band and then use it again later to align the FPC 6. After attaching the battery 8 and FPC 6, the assembly process may further include an over-molding process, such as by using silicon rubber for holding the electronic elements in place. This process may include applying the inner epoxy 15 (e.g., glue, epoxy resin, etc.) to hold the sub-assembly together on the inside portion of the smart ring 20 and also to waterproof the smart ring 20 for protecting the electronics. The over-molding process, in some embodiments, may use a vacuum process for eliminating bubbles or empty spaces.

Smart Ring Assembly after Decorative Element Attachment

After any pre-treatment steps (e.g., polishing, cleaning, etc.) of the decorative element 26 and the outer surface 32 of the circular element 30, the decorative element 26 can be attached (e.g., laser welded) to the outer surface 32, as described above. At this point in the manufacturing process, the foundation element 1 (FIG. 3) is complete and the electronic elements can be added to complete the smart ring 20 (FIG. 1). The following description applies to assembly steps for completing the smart ring 20.

FIGS. 7A and 7B are diagrams illustrating assembly steps for installing the ferrite sheet 4 to the inner surface 34 of the foundation component 1 shown in FIG. 3. Front edges 44 of the ferrite sheet 4 are aligned with a laser etching line 46 on the inner surface 34. Side edges 48 of the ferrite sheet 4 are constrained within protrusions 50 extending from the inner surface 34. This process may include a rolling press.

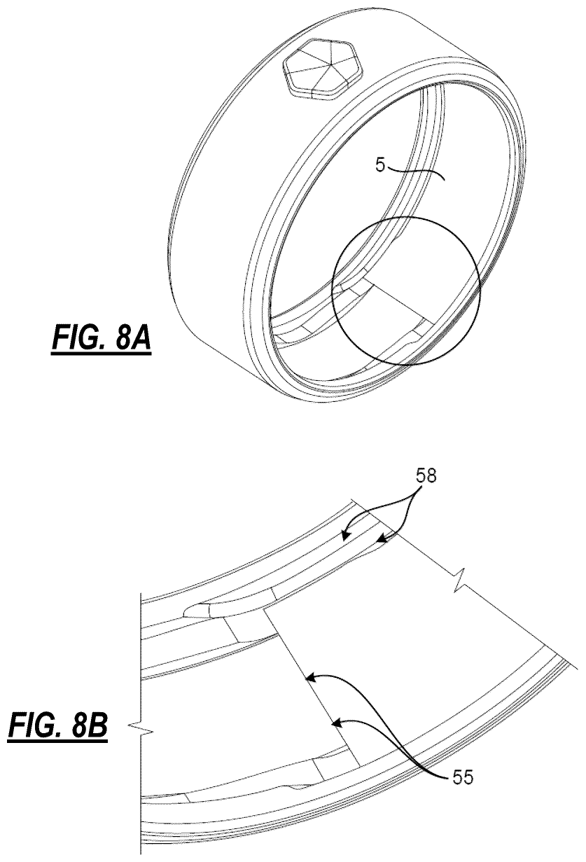

FIGS. 8A and 8B are diagrams illustrating assembly steps for installing the battery tape 5 to the inner surface 34 of the foundation component 1. Front edges 55 of the battery tape 5 are aligned with the laser etching line 46 on the inner surface 34 and may be restrained by the front edges 44 of the ferrite sheet 4. Side edges 58 of the battery tape 5 are constrained within the protrusion 50 extending from the inner surface 34. This process may also include a rolling press.

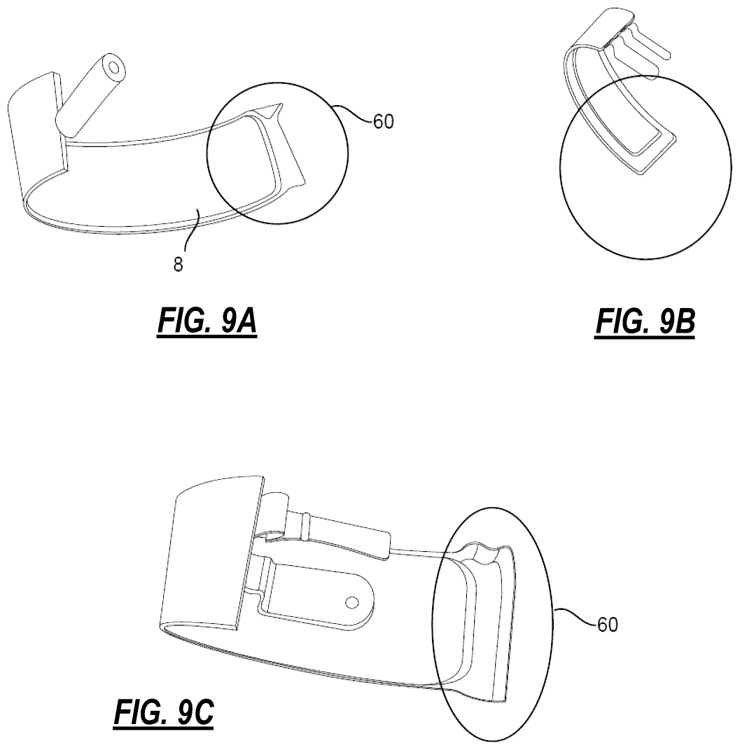

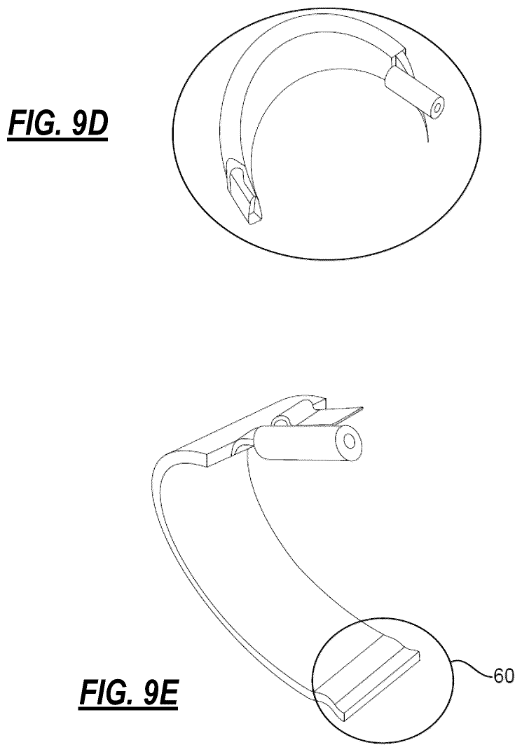

FIGS. 9A-9E are diagrams illustrating assembly steps for forming a groove or pouch shape 60 at one end of the battery 8. These (and other) assembly steps may show the hands of the assembler for performing some of the various steps. The steps of FIG. 9 may be performed after removing any tags attached to the battery 8. FIG. 9A shows the raw material of the battery 8. FIG. 9B shows the use of tweezers to flatten the end of the battery 8 to achieve the pouch shape 60 as shown in FIG. 9C. FIG. 9D shows the assembler using a finger to press on the sidewall of the pouch 60 of the battery 8 to cause the edge to be more vertical in shape. Also, FIG. 9E includes the final appearance of the pouch 60.

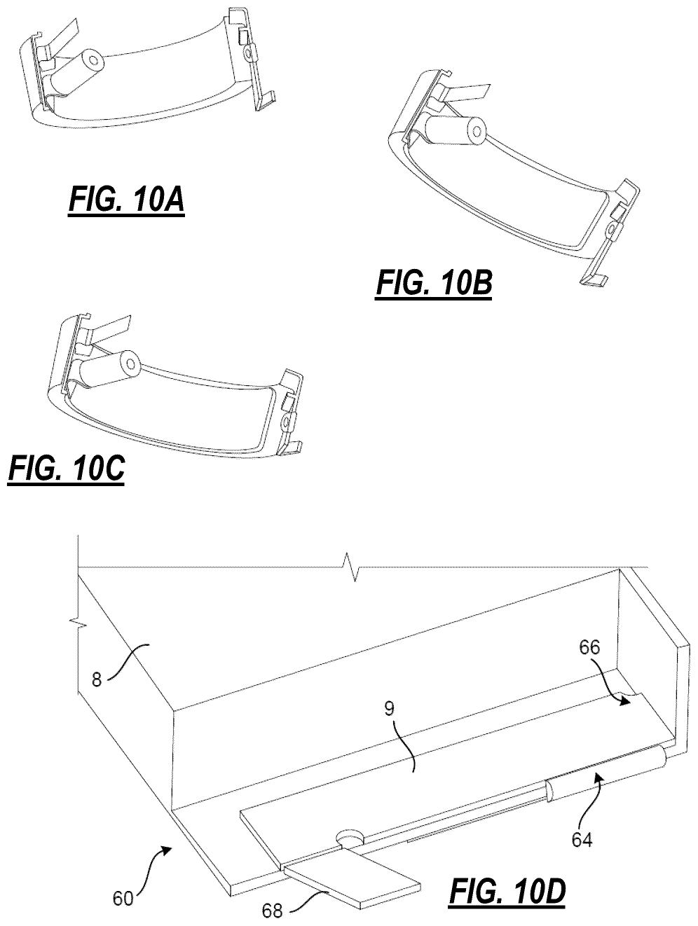

FIGS. 10A-10D are diagrams illustrating assembly steps for installing the metal clip 9 into the groove or pouch 60 in the battery 8. Assembly may include aligning (FIG. 10C) the edge of the metal clip 9 with the battery pouch 60 and then bending (FIG. 10D) a contact 64 around an edge of the battery 8 at one area with the metal clip 9 pushed against a side wall 66 of the pouch 60. One terminal 68 of the metal clip 9 is exposed for later connection.

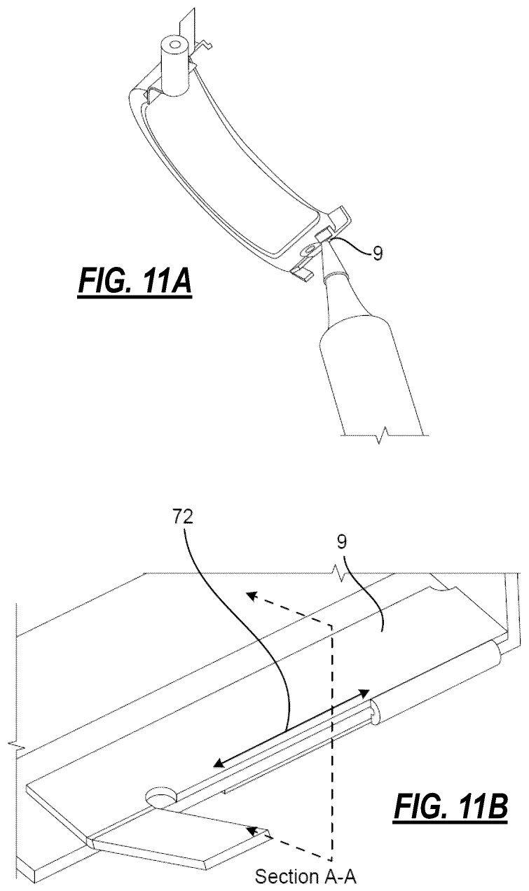

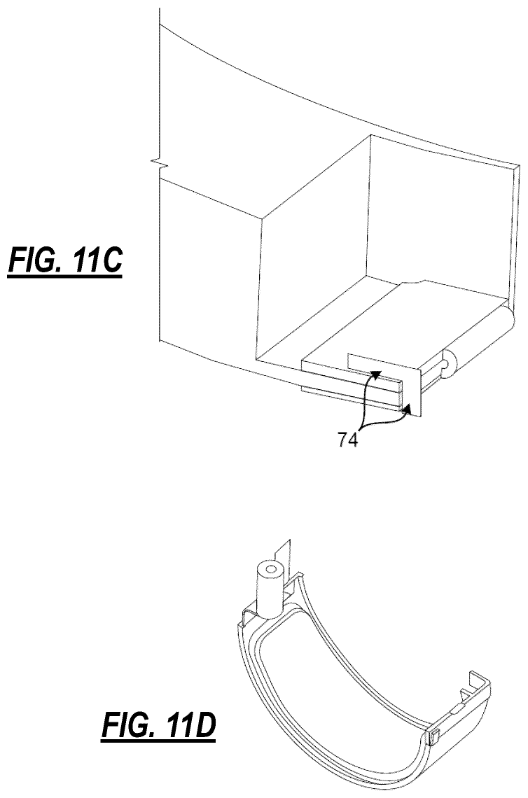

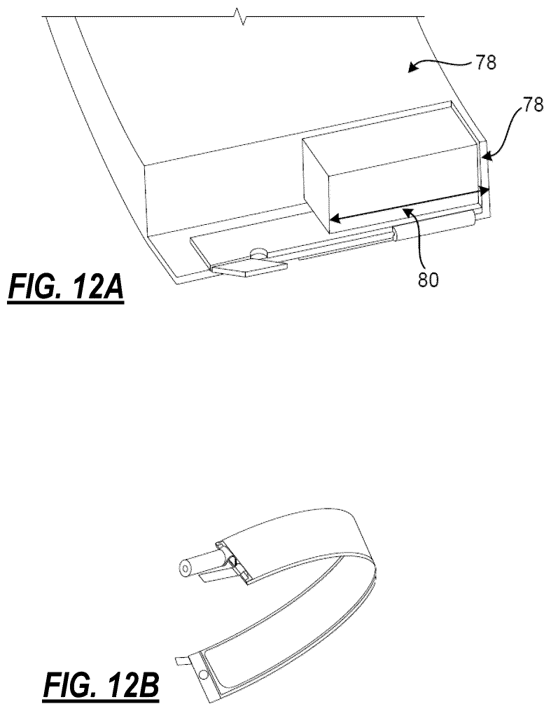

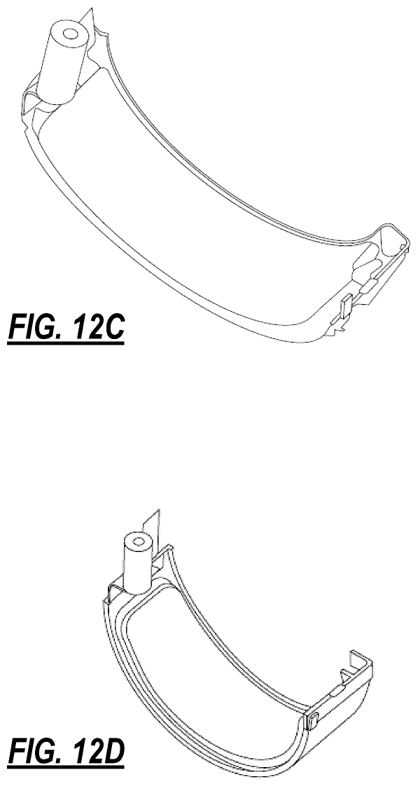

FIGS. 11A-11D are diagrams illustrating assembly steps of soldering the metal clip 9 of FIG. 10 in the groove or pouch 60 of the battery 8. The soldering step is not meant to be confused with a battery gluing step described below with respect to FIG. 12, although some embodiments may include various combinations of the soldering and gluing processes. FIG. 11B shows a soldering area 72, which may have a certain width. FIG. 11C shows portions of solder material 74 that may be applied to top and front sides of the metal clip 9. In some embodiments, the thickness of the solder material 74 may be less than about 0.25 mm. As shown in FIG. 11D, a multimeter may be used to check the properties of the conductive contact between the metal clip 9 and the battery pouch 60.

FIGS. 12A-12D are diagrams illustrating assembly steps for dispensing the battery glue 10 into the groove or pouch 60 of the battery 8. Generally, the assembler may wish to keep the battery glue 10 in a confined space so as not to exceed the top and side surfaces 78 of the battery 8. Also, the assembler will try to keep the battery glue 10 to a width 80 of less than 2.9 mm. The battery glue 10 may include UBW-1333B (black) as shown in FIG. 12B. FIG. 12C shows a dwell time to allow the battery glue 10 to cure (e.g., about four hours). FIG. 12D shows the use of a multimeter to again check the conductive contact between the metal clip 9 and the pouch 60.

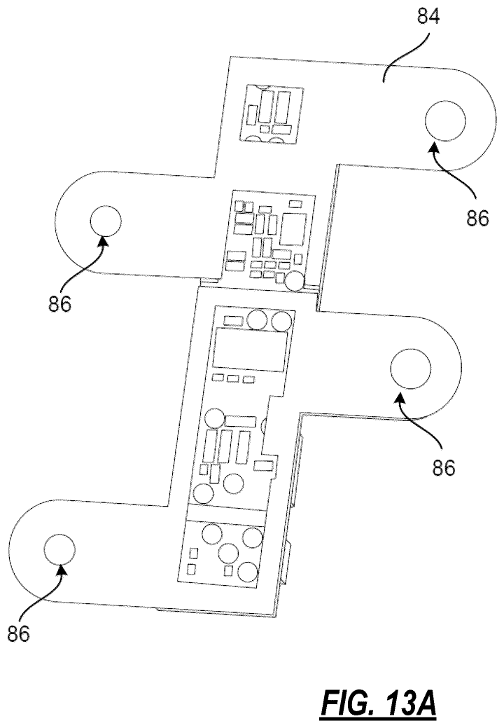

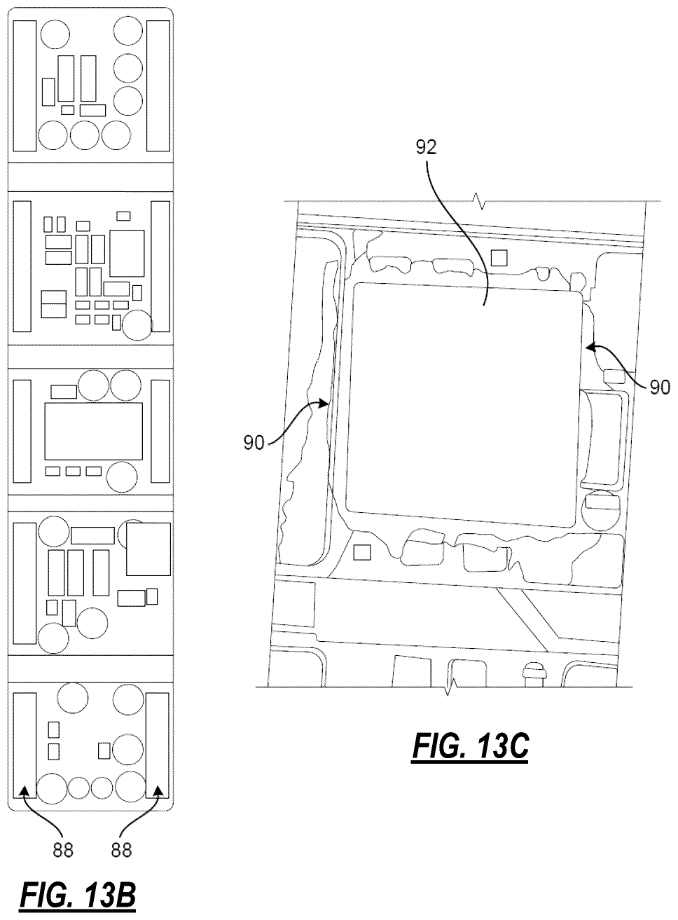

FIGS. 13A-13C are diagrams illustrating assembly steps for installing the Flexible Printed Circuit (FPC) 6 onto the FPC tape 7. In FIG. 13A, an assembly fixture 84 is shown with locating pins 86. FIG. 13B shows the effect of using the FPC tape 7 for mounting the FPC 6. In some embodiments, the FPC tape 7 may be used so as not to exceed edges 88 of the FPC 6. FIG. 13C shows constraints 90 where the FPC tape 7 is not meant to climb up on the edges 88 of an MCU 92 mounted on the FPC 6.

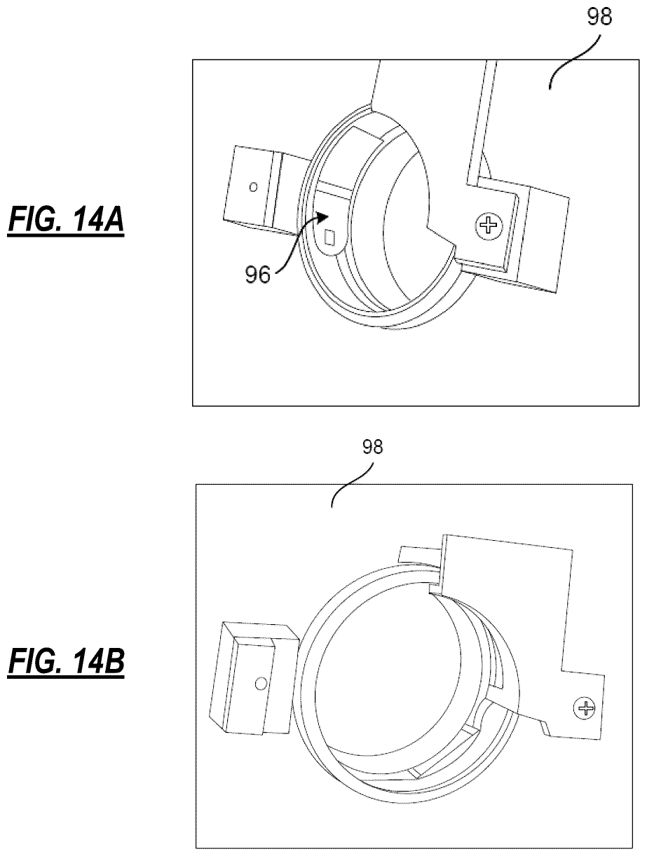

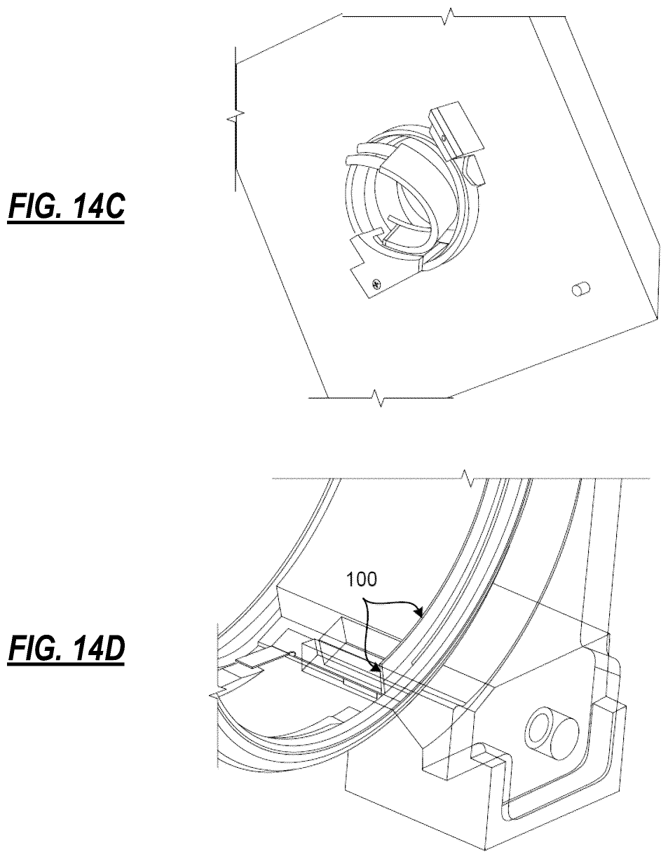

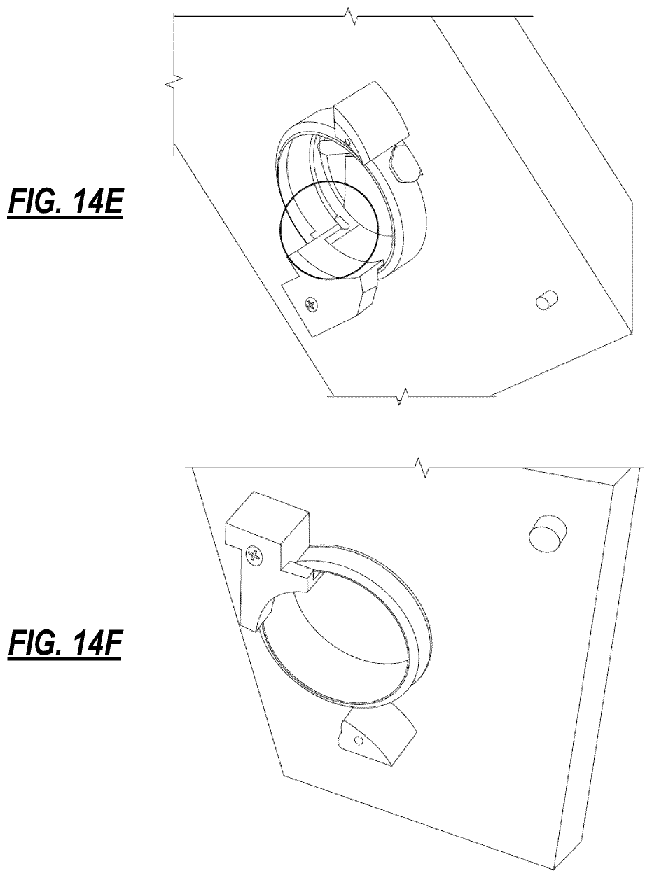

FIGS. 14A-14F are diagrams illustrating assembly steps for installing the battery 8 of FIG. 9 onto the inner surface of the foundation component 1. FIG. 14A shows a line tab 96 on an opposite side of a constraint block of an assembly fixture 98 configured to hold the foundation component 1 during certain assembly steps. FIG. 14B includes the step of placing the foundation component 1 into the assembly fixture 98 and removing a protective liner of the battery tape 5. Then, the battery 8 is placed onto the batter tape 5 on the foundation component 1, as shown in FIG. 14C. Also, as shown in FIGS. 14D and 14E, two sidewall surfaces 100 are placed against the alignment fixture 98 and the battery 8 is fixed to the foundation component 1. FIG. 14F shows the assembler using his or her finger to apply a preliminary pressure onto the battery 8 to assist with connection of the battery 8 to the battery tape 5. Rolling press forces on the battery may be about 2 kgf.

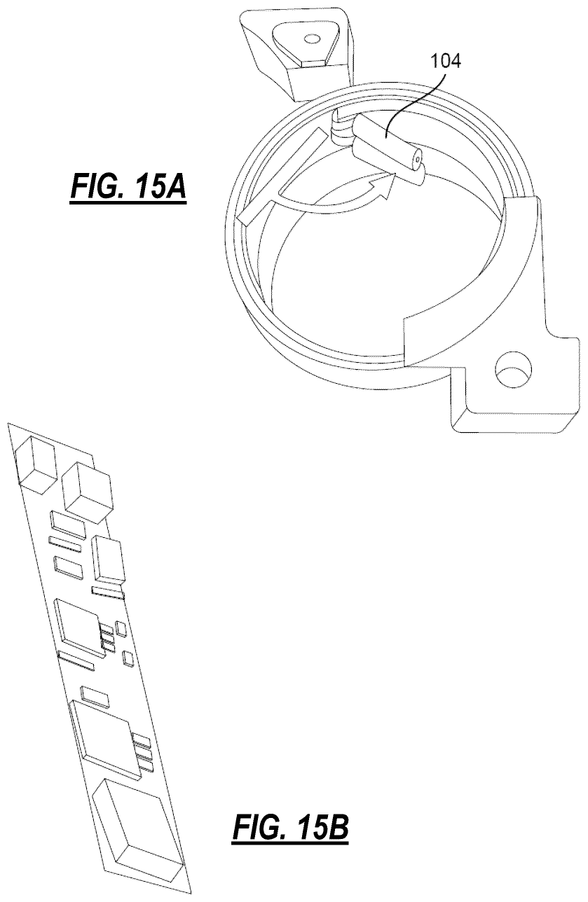

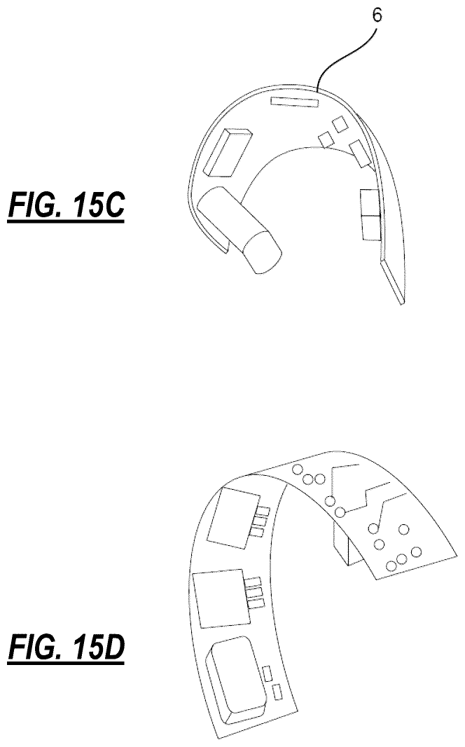

FIGS. 15A-15C are diagrams illustrating assembly steps for pre-bending terminal wires 104 of the battery 8 on the opposite end from the pouch 60. Again, the battery 8 can be held in the assembly fixture 98. The terminal wires 104 are bent in the direction 106 shown in FIG. 15A. Then, the assembler may pre-bend the FPC 6 as shown in FIGS. 15B-15D.

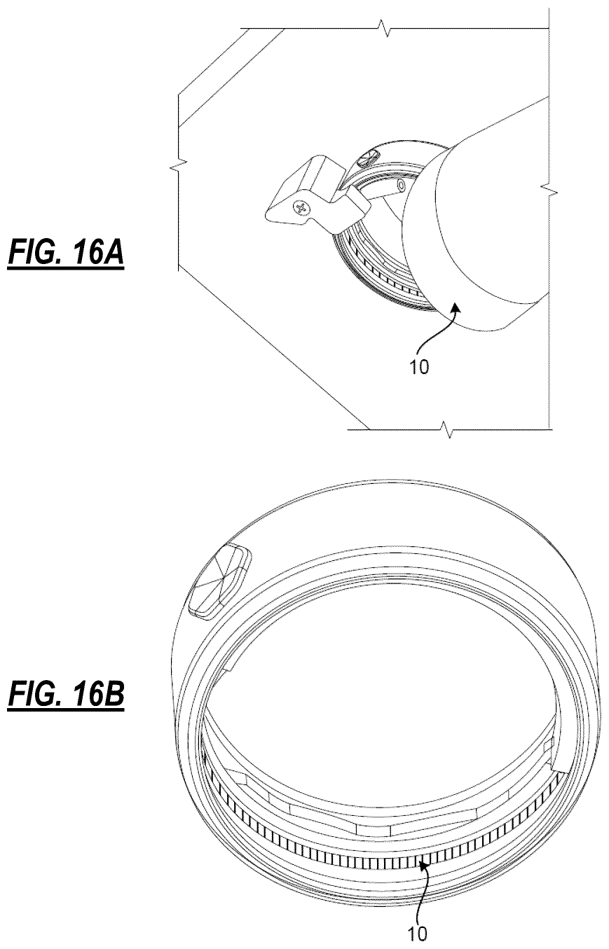

FIGS. 16A and 16B are diagrams illustrating assembly steps for dispensing the FPC glue 11 onto the inner surface 34 of the foundation component 1 for installing the FPC 6. The glue may be UBW-1333B (black). The path, width, and height 110 of the FPC glue 11 may be indicated in Computer-Aided Design (CAD) shown in FIG. 16B.

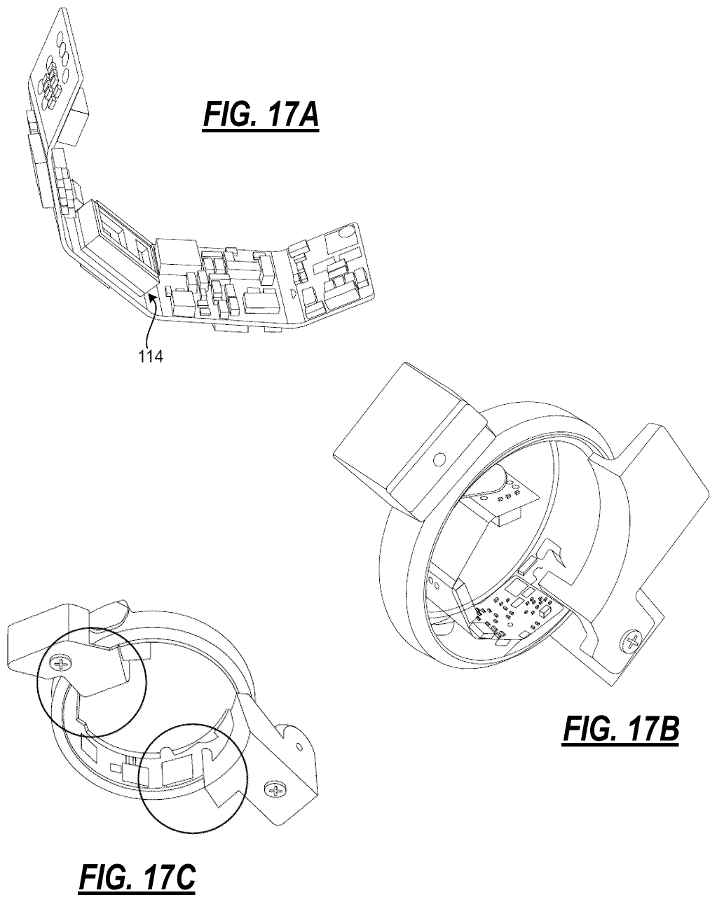

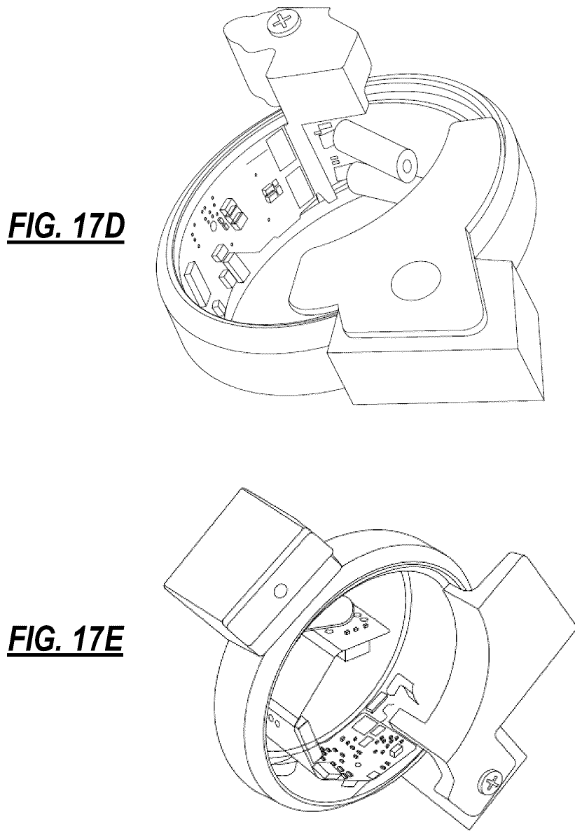

FIGS. 17A-17E are diagrams illustrating assembly steps for installing the FPC 6 onto the inner surface 34 of the band or foundation component 1. FIG. 17A shows a grip position 114 on the FPC 6 where it may be gripped by tools. FIG. 17B shows the step of putting the FPC 6 into the ring in a tilted manner. FIGS. 17C-17E show the steps of locating the FPC 6 using the assembly fixture 98 and then pressing the FPC 6 into contact.

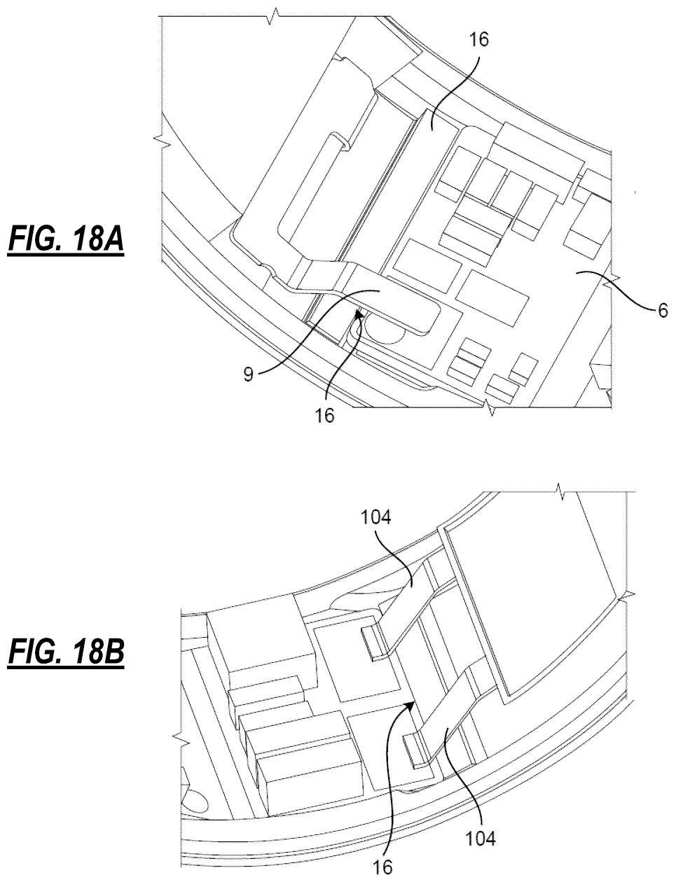

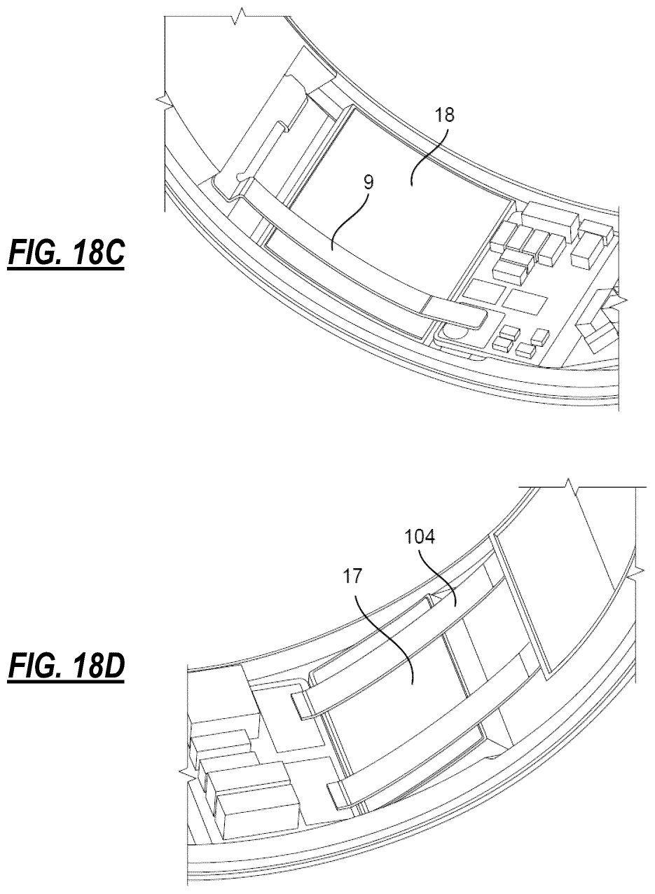

FIGS. 18A-18D are diagrams illustrating assembly steps for installing gap fillers on the inside portion of the band for smart rings 20 having different ring sizes. For example, FIGS. 18A and 18B may be applicable for ring sizes 6-9 and FIGS. 18C and 18D may be applicable for ring sizes 10-14. The small gap filler 16 (FIG. 2A) is installed under the metal clip 9 of the battery 8 and placed against the end of the FPC 6 as shown in FIG. 18A. Another small gap filler 16 (FIG. 2A) is also installed on the other edge of the FPC 6 under the terminal wires 104 of the battery 8, as shown in FIG. 18B. Also, the first large gap filler 17 (FIG. 2B) is installed under the terminal wires 104 against the FPC 6 and the second large gap filler 18 is installed under the metal clip 9 against the opposite edge of the FPC 6, as shown in FIGS. 18D and 18C.

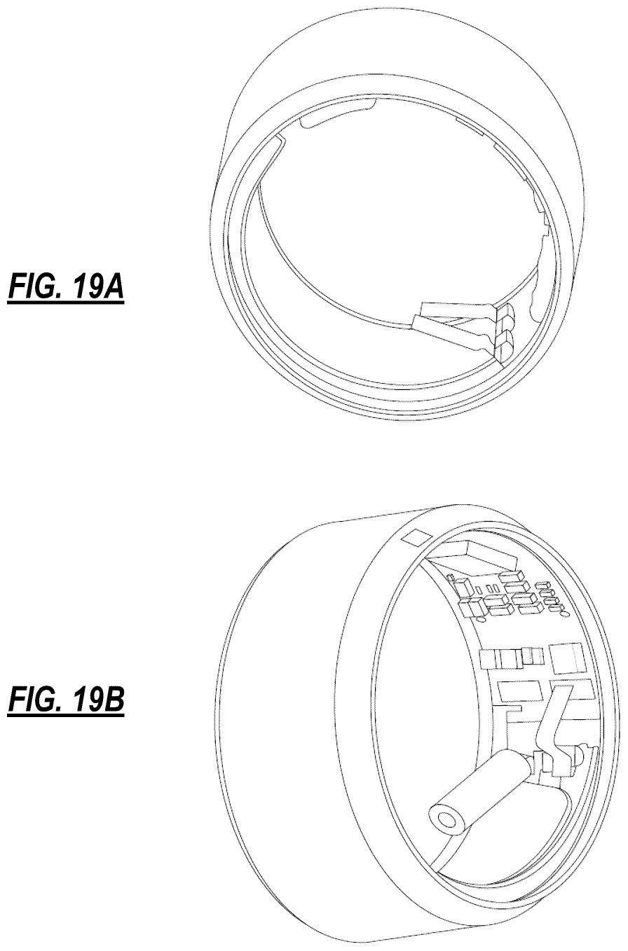

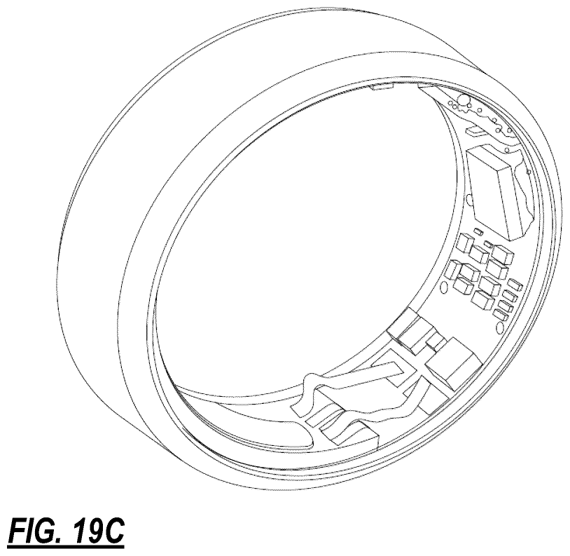

FIGS. 19A-19C are diagrams illustrating assembly steps for bending the terminal wires 104 of the (low-profile) battery 8 for contacting corresponding pads on the FPC. The assembler may use a soldering process to attach the terminal wires 104 to the pads.

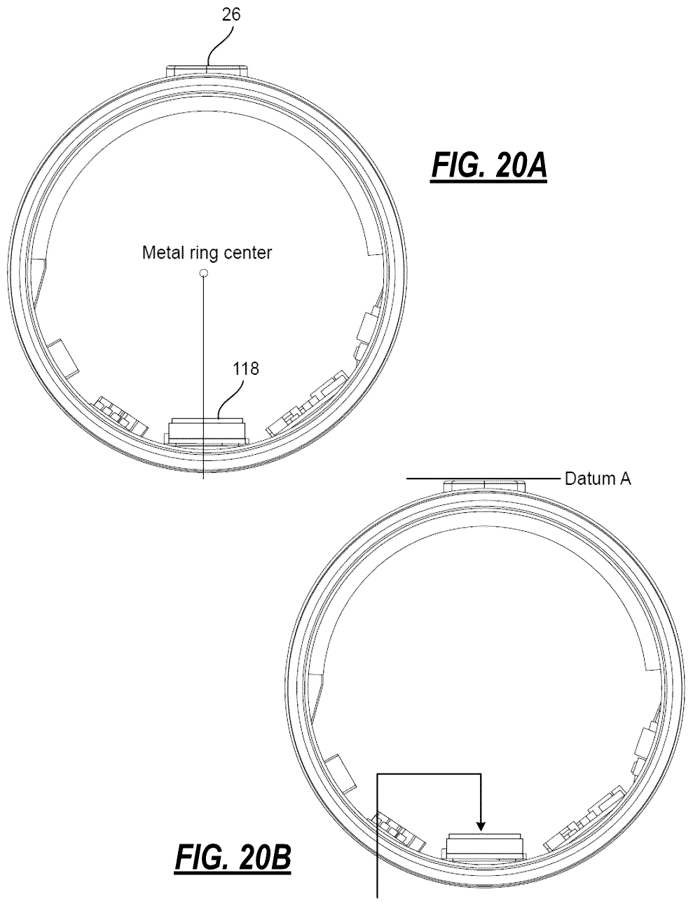

FIGS. 20A and 20B are diagrams illustrating assembly steps for checking the position of a sensor 118 mounted on the FPC 6. For example, the sensor 118 may be a heart rate sensor, an optoelectronic sensor (e.g., Photoplethysmography (PPG) sensor) for detecting LED reflection, or other type of sensor. In some embodiments, the sensor 118 may be positioned on the ring opposite from the decorative feature 26. From an alignment point of view, the sensor 118 may be center with the ring's center within a reasonable tolerance.

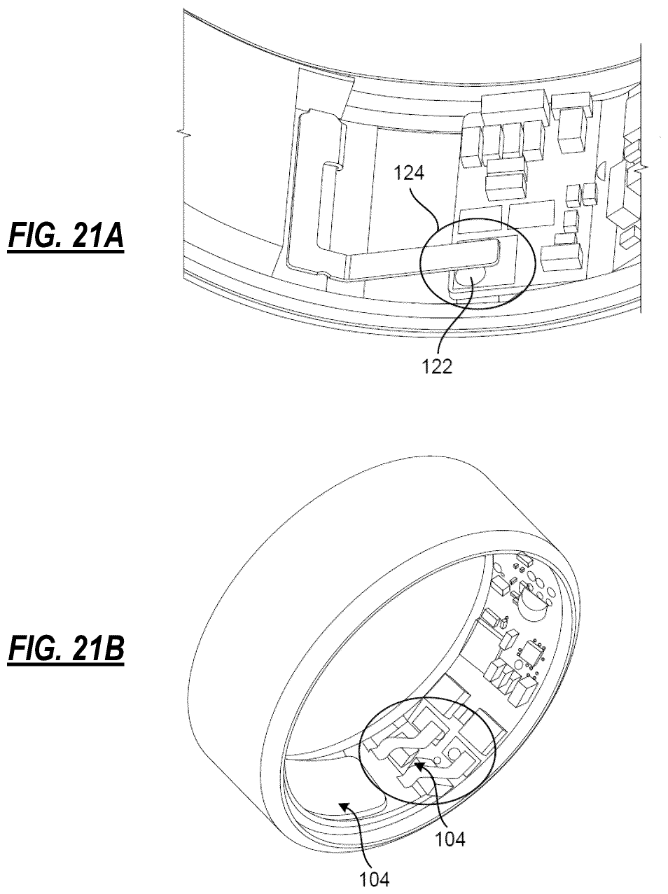

FIGS. 21A and 21B are diagrams illustrating assembly steps for attaching a Bluetooth antenna 122 to a pad 124 of the FPC 6. This may include soldering the Bluetooth antenna 122 onto the pad 124 (FIG. 21A). Also, the process may include soldering the battery terminal wires 104 onto a pad of the FPC 6 (FIG. 21B). The two terminal wires 104 may be soldered so as not to exceed a surface of the pouch 60 of the battery 8.

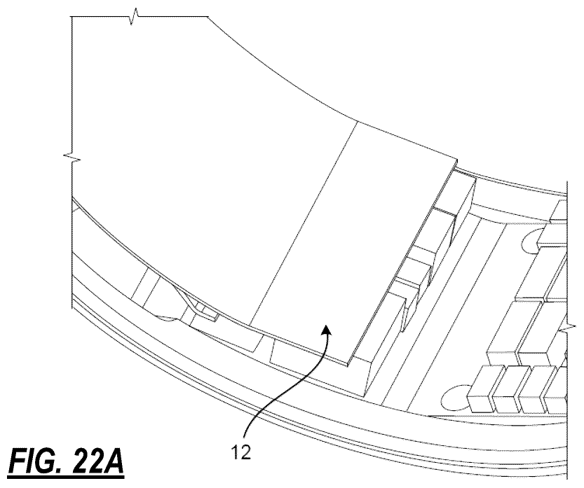

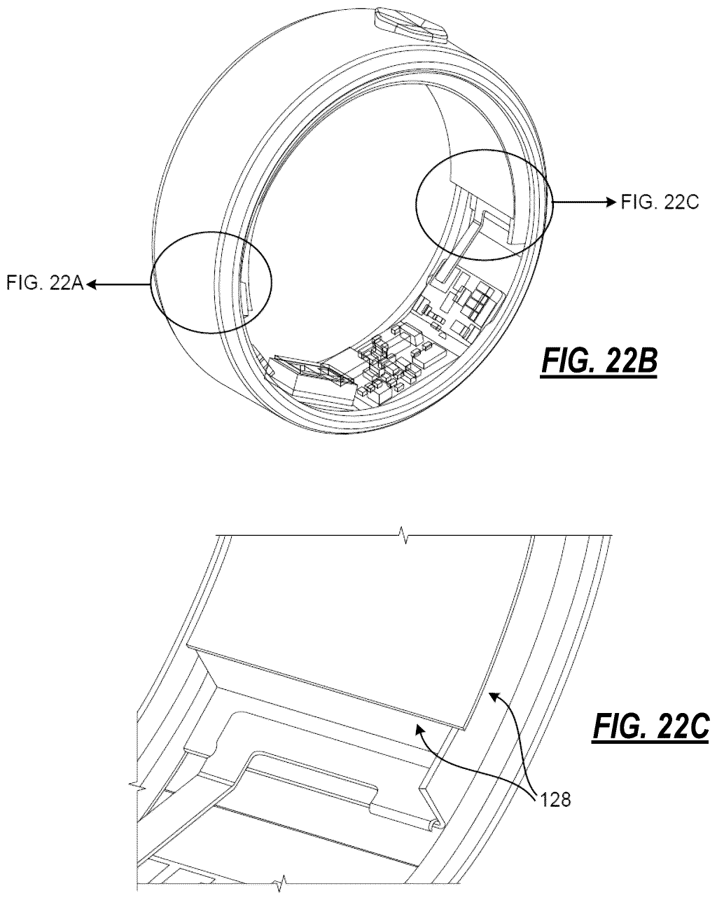

FIGS. 22A-22C are diagrams illustrating assembly steps for installing the ferrite sheet 12 to the battery 8. The end of the ferrite sheet 12 may to attached to two components. FIG. 22A shows the attachment at one end while FIG. 22C shows the attachment at the other end. As also shown in FIG. 22C, the features 36 of the inner surface 34 may include a fixture 128 that can be used to position the ferrite sheet 12.

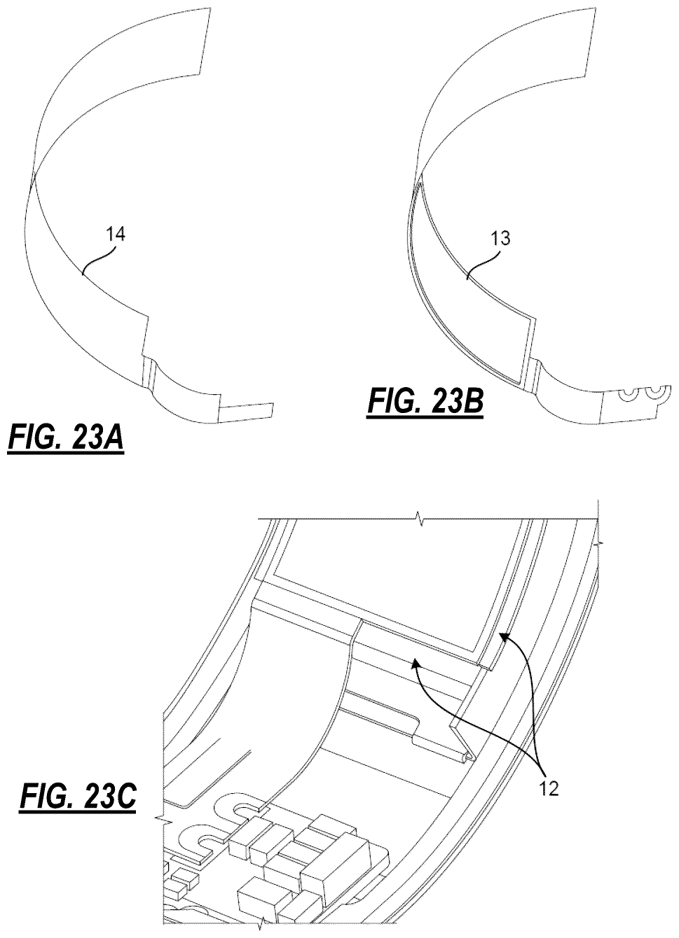

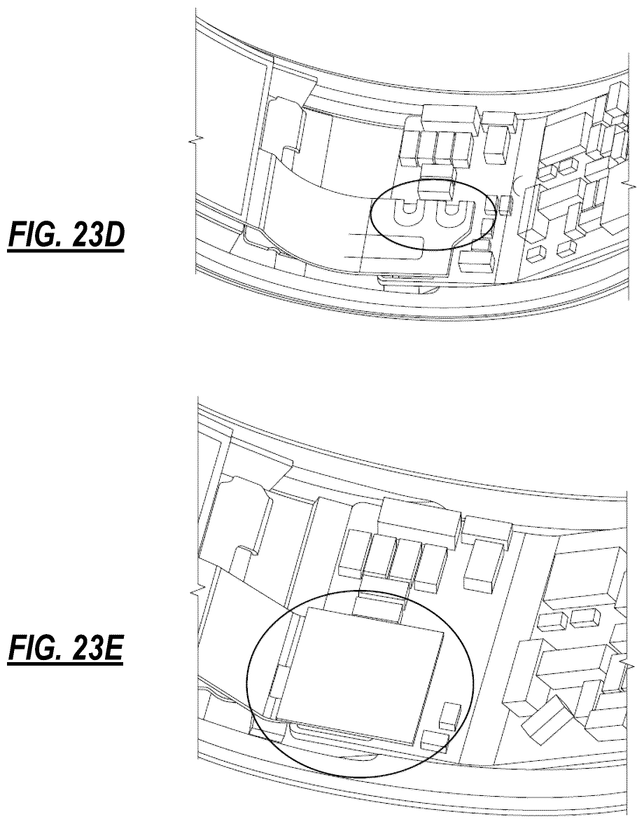

FIGS. 23A-23E are diagrams illustrating assembly steps for attaching the Near Field Communication (NFC) device 13 at the inside portion of the band. FIG. 23A shows the NFC tape 14 and FIG. 23B shows the NFC device 13. The NFC tape 14 can be attached to the NFC device 13 before pre-bending the NFC device 13. FIG. 23C show the installation of the NFC device 13 onto the pouch 60 of the battery 8. The features 36 of the inner surface 34 may be used to position NFC device 13. FIG. 23D shows a step for soldering the NFC device 13 onto a pad of the FPC 6. FIG. 23E shows a step of assembling NFC Rx FPC pad mylar onto the FPC 6. This concludes the sub-assembly procedure.

### Epoxy Molding

Thus, the assembly steps described above with respect to FIGS. 7-23 are performed to complete a sub-assembly 140 of the smart ring 20. Once the sub-assembly 140 is complete, then an epoxy molding process may be performed, which is configured to hold the electronic components in place and protect them from water damage and dirt. Also, the epoxy may be formed on the inside surface of the smart ring 20 to give it a comfortable feel for the wearer.

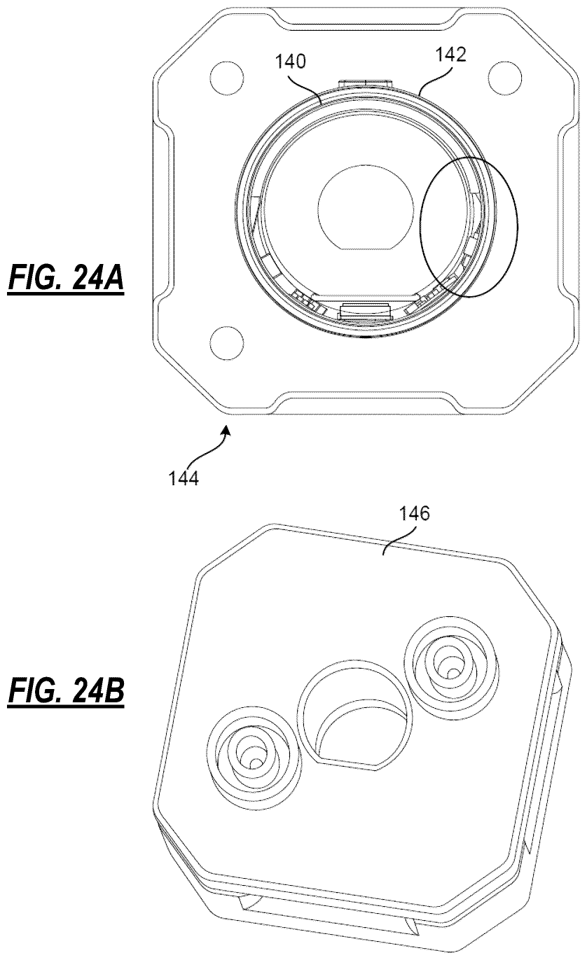

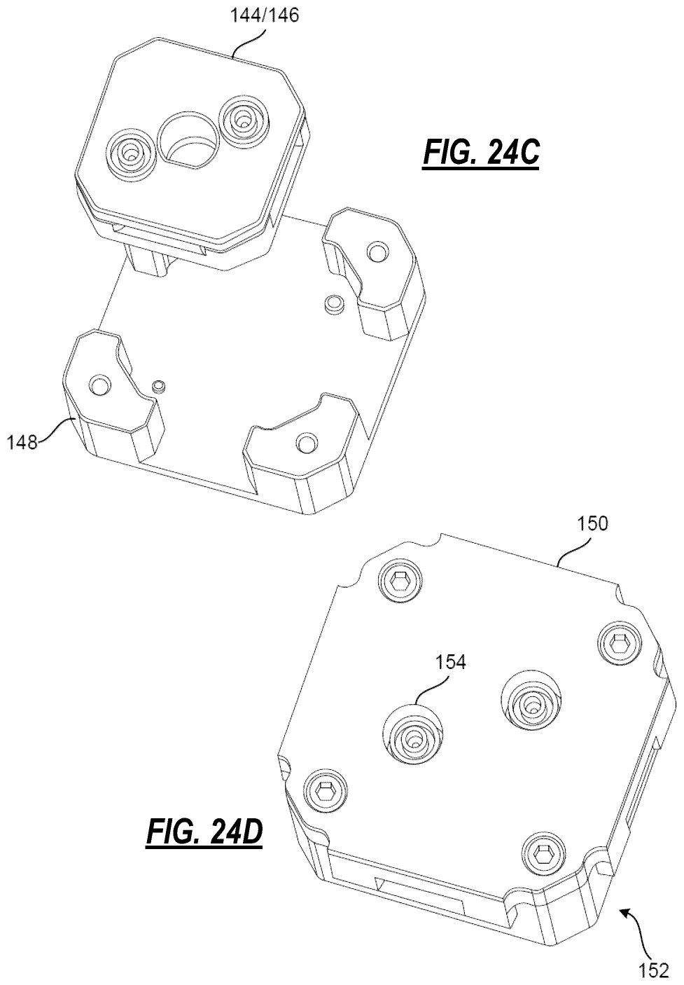

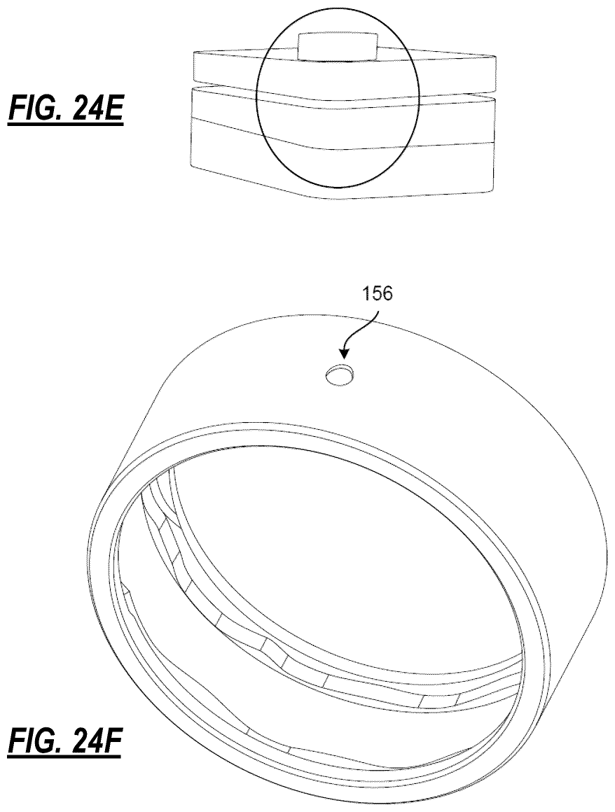

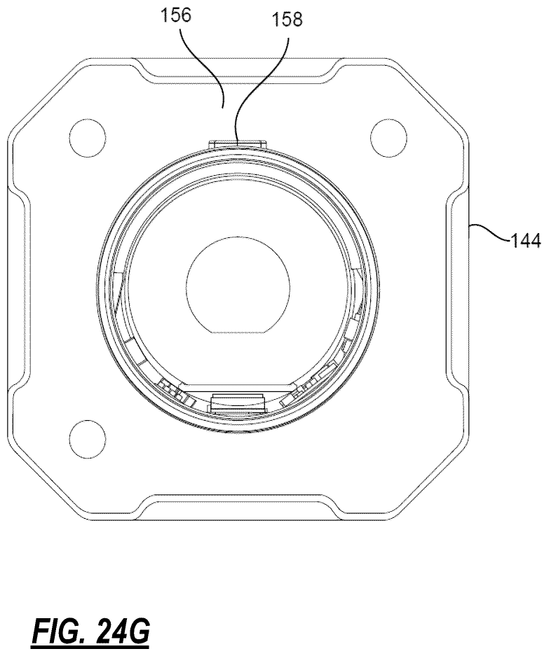

FIGS. 24A-24H are diagrams illustrating assembly steps for molding epoxy over the electrical components on the inside surface of the smart ring 20. The sub-assembly 140 is placed into a ring-shaped cavity 142 of a base unit 144, which may be particularly tailored for a certain ring size. The sub-assembly 140 is oriented in the ring-shaped cavity 142 whereby the features corresponding to the width expanded portion 24 of the smart ring 20 are positioned near the bottom of the base unit 144 and the features corresponding to the decorative element 26 of the smart ring 20 are positioned near the top of the base unit 144. A fixture cover 146 is placed over the base unit 144 to enclose the sub-assembly 140. FIG. 24C includes the step of locating the base unit 144 and fixture cover 146 onto a clamping fixture 148 (FIG. 24C). A lid 150 is placed over the clamping fixture 148 to complete an epoxy molding fixture 152 that is used to form the inner epoxy 15 around the electronic circuitry. The fixture cover 146 and lid 150 have inlet apertures for applying epoxy. After waiting for the epoxy to set or cure, the process includes the step of opening the epoxy molding fixture 152 corner by corner, as shown in FIG. 24E.

In addition, the steps associated with FIGS. 24F and 24G may be performed during the epoxy molding procedure. For the orientation of a fake ID ring placement, a hole 156 may be formed in the circular element 30. The hole 156 on the fake ID may be aligned with the center line of the decorative element 26 and/or the locating feature 38 (FIG. 4), for example, on the bottom of the base unit 144. A center line 158 of the hole 156 and/or locating feature 38, associated with the positioning of a cutout for the decorative element 26 may be formed at the bottom of the base unit 144 of the epoxy molding fixture 152.

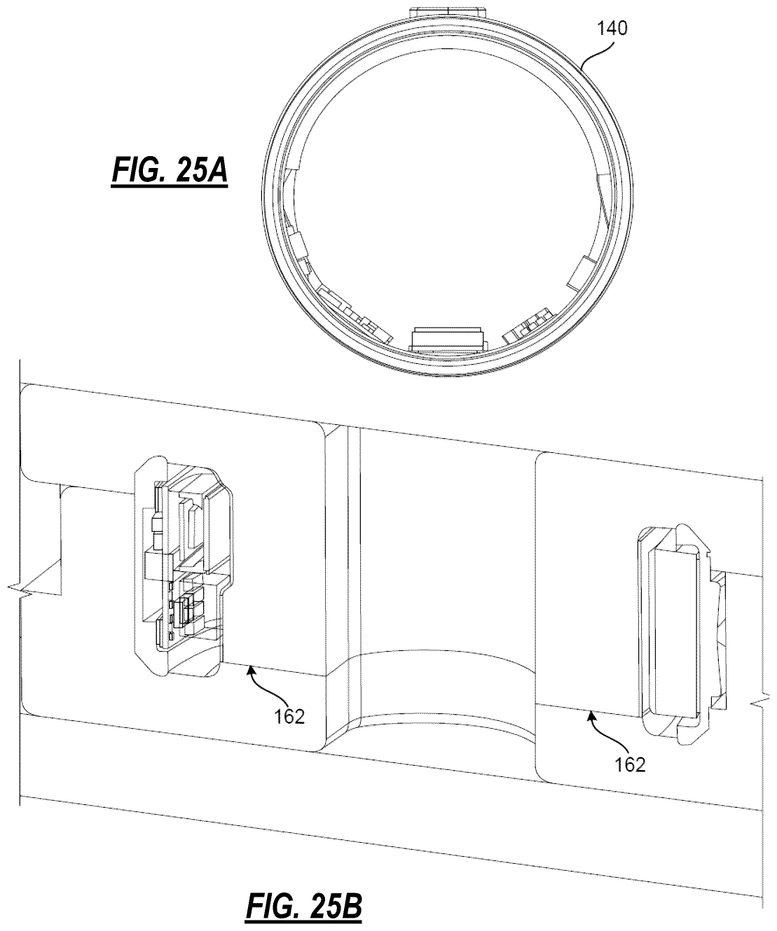

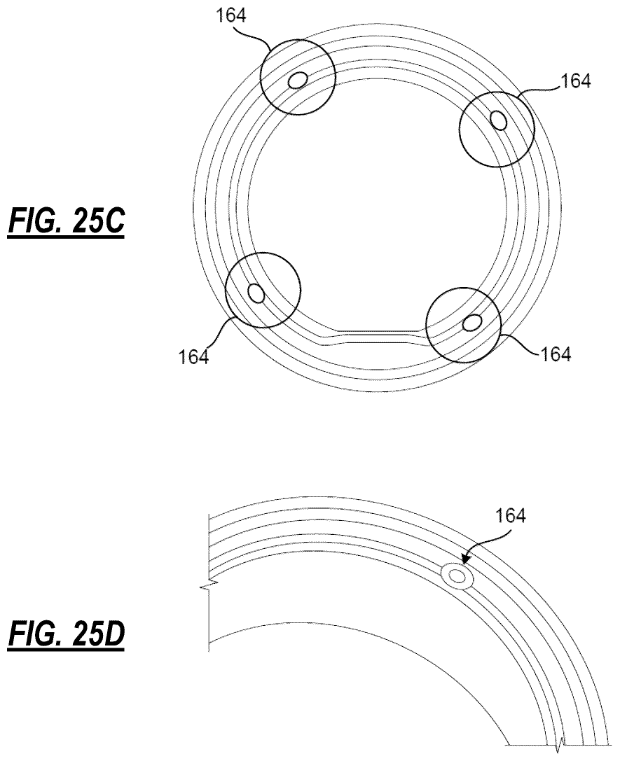

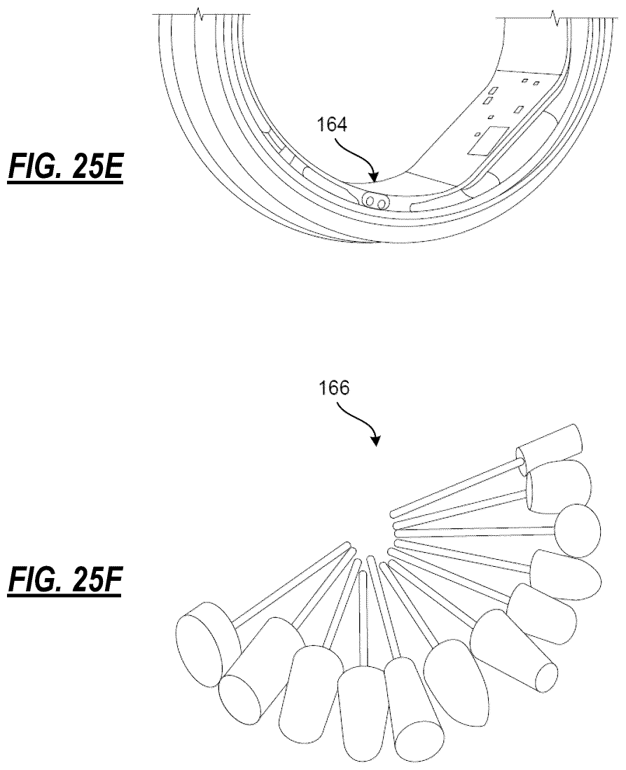

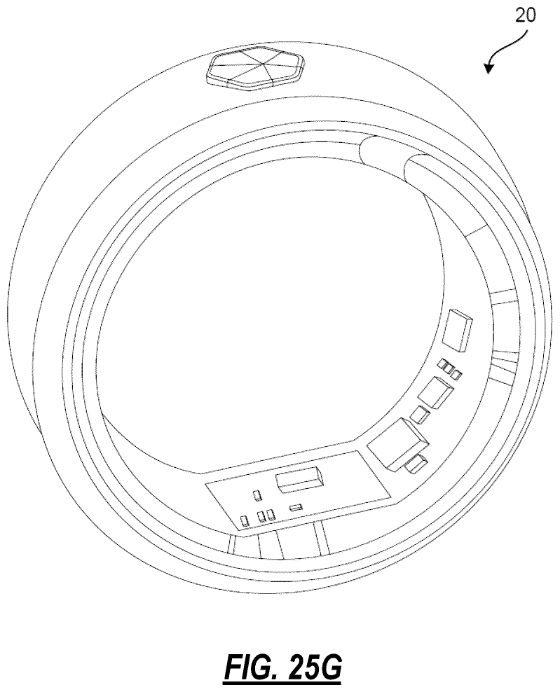

FIGS. 25A-25G are diagrams illustrating assembly steps for gluing and buffing the sub-assembly 140 of the smart ring 20. FIG. 25B shows a cross-section of the epoxy molding fixture 152 and where the inner epoxy 15 is directed through an inlet gate 154 of the mold to embed the electronic components. The inner epoxy 15 or glue includes an epoxy flash existence 162 around the fixture. FIGS. 25C-25E show glue outlet gates. Once the sub-assembly 140 is removed from the mold, the assembler may perform polishing or buffing steps. Buffing may include felt buff tools 166. The assembly may use the felt buff tools 166 to remove the gate vestige and flash around the PL in the area 1 to 3 after epoxy curing and the ring is removed from the molding fixtures. FIG. 25G shows the buffed finished product of the smart ring 20.

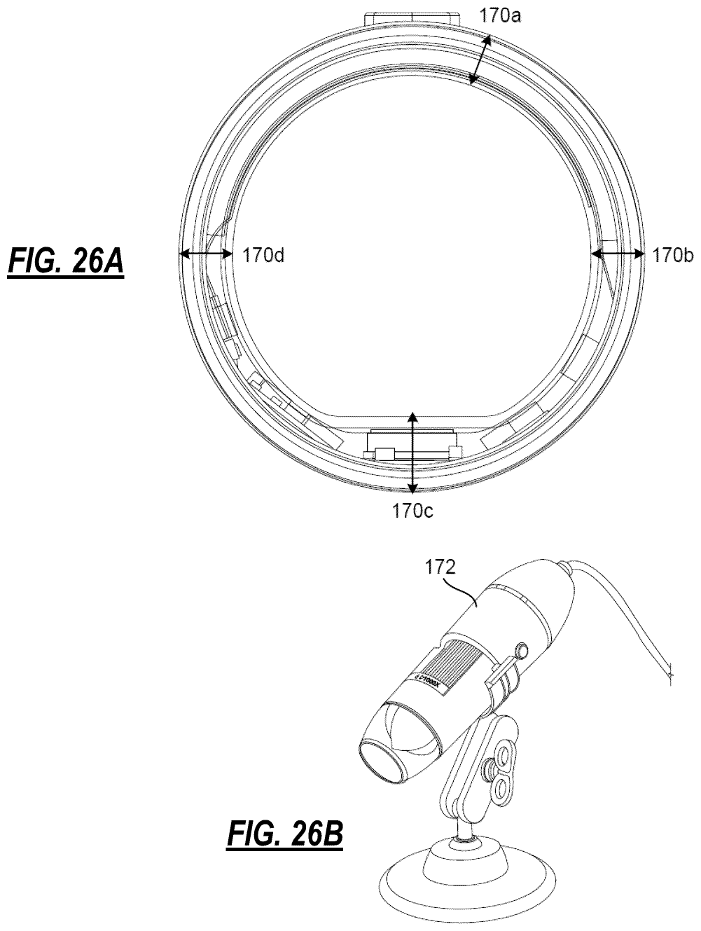

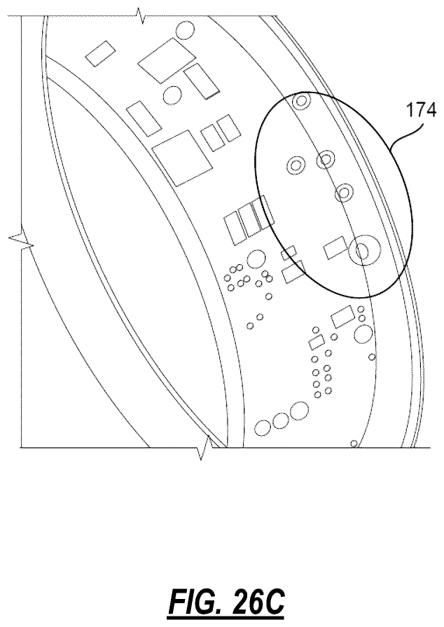

FIGS. 26A and 26B are diagrams illustrating steps for checking sidewall thicknesses of the smart ring 20. Thickness of the sidewalls may be checked at each of a number of areas, such as points 170a, 170b, 170c, and 170d. For example, at point 170c, the thickness may be checked to determine if the sidewall is a certain width (e.g., 3.65 mm) plus or minus certain tolerances (e.g., +0.1 mm and −0.15 mm). The other points 170a, 170b, 170d may be checked to determine if the sidewall is a certain width (e.g., 2.6 mm) plus or minus certain tolerances (e.g., +0.1 mm and −0.07 mm). FIG. 26B shows a microscope 172 (e.g., Dino microscope), which may be used to check if there are any bubbles 174 on the inner ring, where FIG. 26C shows a defective sample with bubbles 174. The bubble check on the inner ring may include detecting in a detection distance, for example, of about 10 cm.

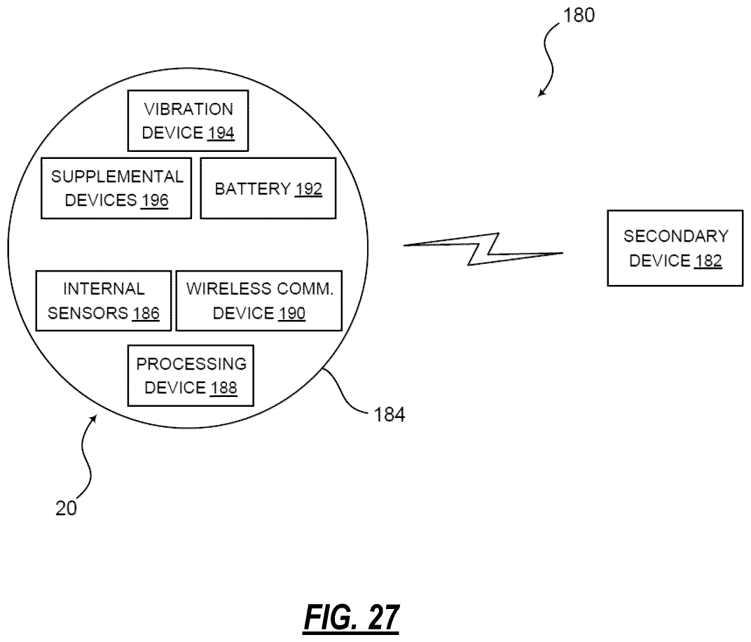

FIG. 27 is a diagram illustrating an embodiment of a short-range wireless communication sub-system 180 in which the smart ring 20 is configured to wirelessly communicate with one or more external electrical components, such as a secondary device 182. The secondary device 14 may be any suitable device that may be used in a wireless network or Wi-Fi network, such as an access point device, modem, router, etc. The smart ring 20 can be any type of wearable device, necklace, lanyard, strap, pendant, smart glasses, smart watch, mobile device, etc., which can be worn or carried by a user.

In some embodiments, the smart ring 20 may include a casing 184, housing, etc. that is configured to surround and protect internal electrical circuitry. For example, the casing 184 may include the exterior exposed portions of the smart ring 20, including both the outer surface 32 of the band 22 and the inner epoxy 15 formed over the electronic components. Internal circuitry may include one or more internal sensors 186, a processing device 188, a wireless communication device 190, and a battery 192. The one or more internal sensors 18 may include one or more accelerometers, one or more gyroscopic devices, one or more capacitance sensors, one or more NFC signal detection devices, one or more optoelectronic sensing devices, etc. In some embodiments, the internal circuitry of the smart ring 20 may also include other supplemental devices 196 (e.g., one or more microphones, cameras, speakers, tone generators, light generating devices, LEDs, etc.) and a vibration device 194 for providing haptic or tactile feedback to the user.

Furthermore, according to some embodiments, the smart ring 20 may be used in a Wi-Fi network or local network in a home setting or office setting, where Wi-Fi may operate in accordance with the IEEE 802.11 protocols and variations thereof. The Wi-Fi networks may be deployed to provide coverage in a physical location (e.g., home, business, store, library, school, park, etc.). The different topologies of the Wi-Fi networks may provide different scopes of physical coverage. For example, the Wi-Fi networks may include various arrangements, such as a single access point arrangement, a Wi-Fi mesh network arrangement, an arrangement having one or more Wi-Fi repeaters, etc.

### General Manufacturing Process

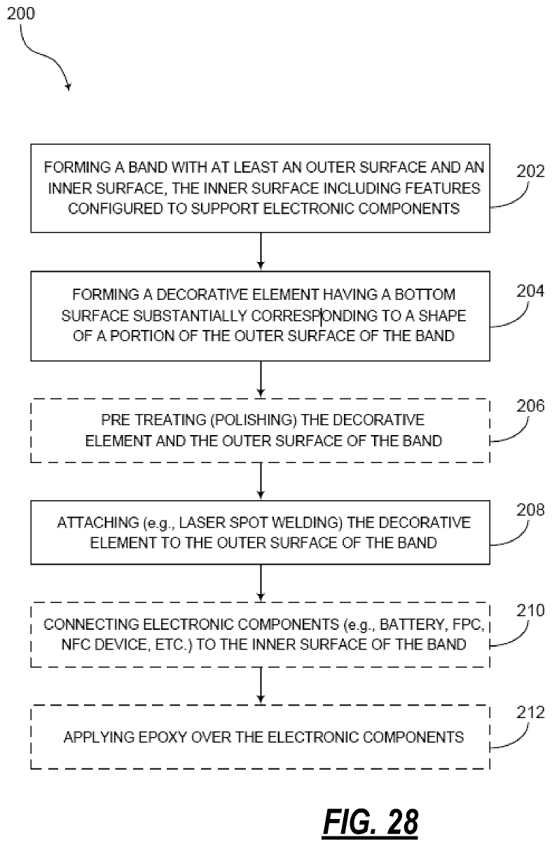

FIG. 28 is a flow diagram showing an embodiment of a process 200 for manufacturing a smart ring (e.g., smart ring 20). As illustrated, the process 200 includes the step of forming a band with at least an outer surface and an inner surface, the inner surface including features configured to support electronic components, as indicated in block 202. The process 200 further includes the step of forming a decorative element having a bottom surface substantially corresponding to a shape of a portion of the outer surface of the band, as indicated in block 204. After forming the band and decorative element, the process 200 may optionally include the step of pre-treating (e.g., polishing) the decorative element and the outer surface of the band, as indicated in block 206. The process 200 also includes attaching the decorative element to the outer surface of the band, as indicated in block 208. For example, the attaching step (block 208) may include laser welding or spot welding the inner surface of the band to attach the decorative element to the band.

Furthermore, after attachment of the decorative element to the band, a foundation component will have been completed and additional steps may be performed to thereafter complete the final product (e.g., smart ring). For example, the process 200 may also include the step of connecting electronic components (e.g., battery, FPC, NFC device, etc.) to the inner surface of the band, as indicated in block 210. This connecting step (block 210) may include the use of tape, glue, etc. for connecting the electronic components to the band. Finally, the process 200 of manufacturing the smart ring may include the step of applying epoxy over the electronic components, as indicated in block 212, to protect the electronic components and to provide comfort for the wearer.

### Improved Waterproofing

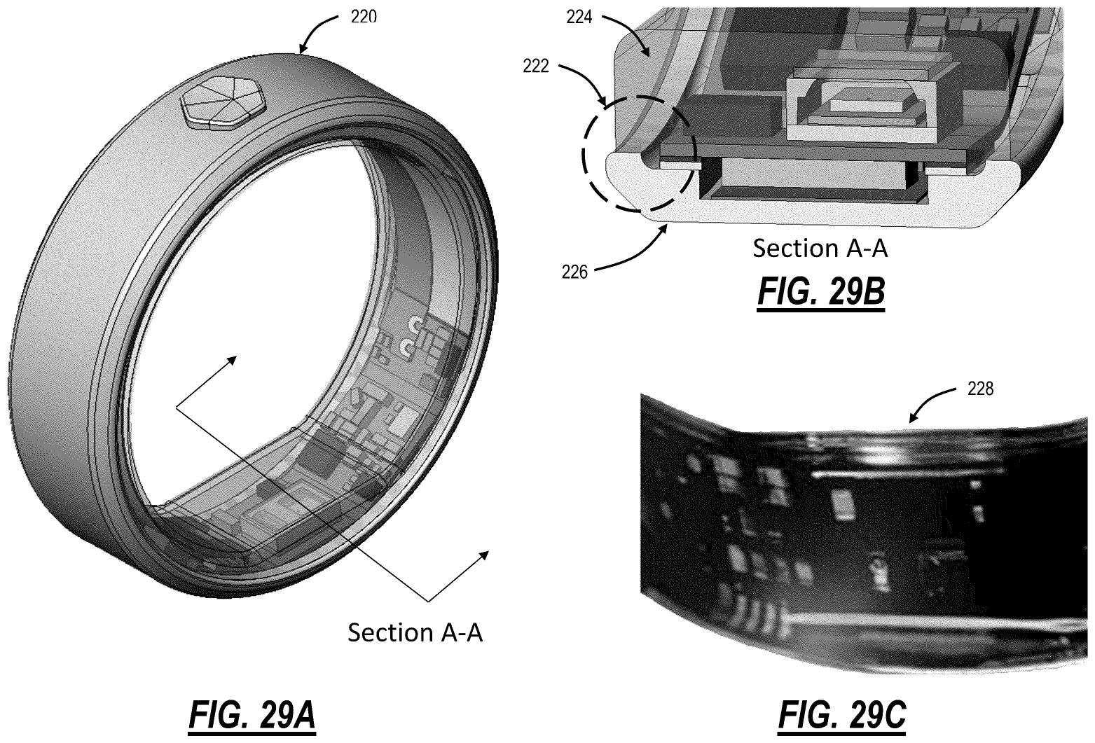

FIG. 29A-29C illustrates the typical waterproofing design and manufacturing process implemented into the smart ring 220. As depicted in FIG. 29A the assembled smart ring inner and outer surface of the band is shown where the outer surface is metal or similar and the inner surface includes an epoxy molding process which is configured to hold the electronic components in place and protect them from water damage and dirt. The epoxy may be formed on the inside surface of the smart ring 224 to give it a comfortable feel for the wearer. A section view of the assembled ring is shown in FIG. 29B where the outer metallic surface 226 and inner epoxy surface 224 is detailed. Detailed in this view is the contact area that exists between the epoxy glue 224 and the outer metallic surface 226 which is detailed by a dotted circle 222. The bonding surface available for the epoxy glue is a flat smooth surface where the epoxy needs to adhere and provide a waterproof barrier. The epoxy being a continuous process provides excellent water protection, the area of susceptibility for water intrusion is in the area where the epoxy contacts the metallic outer surface of the smart ring shown circled in 222. It is detailed in 222 that the metallic outer surface of the ring is smooth and flat where the epoxy glue makes contact and provides the bond between the two elements. As can be seen in FIG. 29C testing using red dye has shown that water intrusion has occurred at the bonding point where the epoxy glue contacts the metallic portion of the ring (228). This red dye intrusion (228) occurred inside the ring after consecutive testing of thermal shock and 5 atm water submersion. The pressure that occurred in this testing caused delamination or separation between the epoxy glue and the ring metallic surface. Better adhesion and bonding between the metallic ring and the epoxy is critical to achieve a 5 atm waterproof rating. This 5 atm rating is critical to accommodate daily activities of the wearer as this ring is designed to wear throughout the day without the inconvenience of taking measures to keep the ring away from water intrusion.

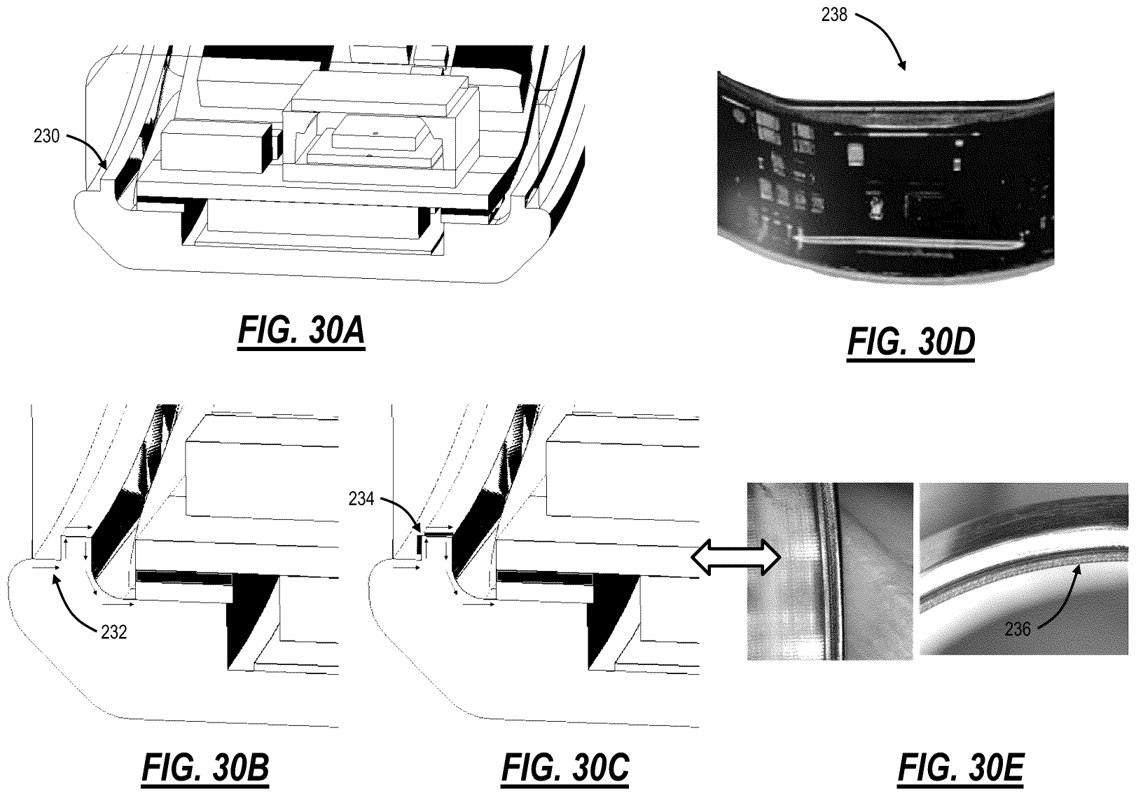

FIG. 30A-30E illustrates an improved waterproofing design and manufacturing process where the susceptibility of water intrusion between the epoxy glue and the metallic ring is eliminated during the 5 atm water resistance testing. It is known that there are certain surface preparation methods that can give best results when using epoxy glue on a non-porous material such as metal. These surface preparation methods can include cleaning the surface to remove contaminants and drying the surface to ensure a completely dry surface. Another method of surface preparation can include abrading the surface to allow greater adhesion, this is typically achieved by using sandpaper, emery cloth, or using a chemical pretreatment.

The design and manufacturing process applied to this smart ring to improve waterproofing includes two main features which includes manufacturing an edge rib on the flat metallic surface (222) and abrading the edge rib with laser etching technology. The existence of an edge rib is shown implemented into the ring (230) where the otherwise flat metallic surface now has an elevated edge rib in at least a portion of the surface of the metallic band. As further depicted in 232 the arrows indicate the flow of water that would need to occur in order to have water intrusion into the ring and affect the electrical circuitry. This edge rib with the epoxy covering the entirety of the edge rib in itself greatly reduces any water intrusion even if the epoxy becomes delaminated. This edge rib can be manufactured as part of the metallic band as a complete assembly utilizing the same manufacturing process that is described in the disclosed.

The second feature applied to this smart ring to eliminate water intrusion is to abrade the surface of the edge rib (230) shown on the top and side of the edge rib (234). The edge rib and abrasion shown in FIG. 30C occurs using laser etching technology which melts the micro surface of the metal to create permanent raised marks and creates an abrasive surface. This laser etching technology is used in automated manufacturing environments such as the one that would be used to manufacture this smart ring and will provide very shallow depth of abrasion in addition to narrow separation between laser etched lines that cannot be realistically performed by other manufacturing means. The laser etching can also provide a greater consistency for the abrasion design thereby providing a consistent product that can be based on the optimized design for optimizing bonding to the epoxy. The laser etching on the top and the side of the edge rib as detailed in FIG. 30C provides excellent adhesion between the epoxy and the metallic surface. Further illustrated in FIG. 30E is the finished metallic band with the laser etching treatment applied in the manufacturing process. The edge rib (236) can be seen elevated above the metallic surface physically extended outward from the inner surface in the same direction as the electronic components. The laser etching technology allows a shallow and narrow abrasive surface which would accommodate the small form factor of the smart ring and the small edge rib surface area. The 5 atm water test result is shown in FIG. 30D with the finished smart ring having the edge rib addition and the laser etching treatment as described. This illustration depicts a view of the inside of the smart ring after the pressure test has been completed. As shown, there is no water ingress after the environmental testing of thermal shock to the ring. The red dye intrusion into the smart ring circuitry is eliminated when the edge rib and laser etching is applied to the smart ring. This can be clearly observed when comparing the illustration of the red dye intrusion (228) to the smart ring after the 5 atm water test with the implementation of the edge rib and laser etching (238).

### Conclusion

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

The foregoing sections include headers for various embodiments and those skilled in the art will appreciate these various embodiments may be used in combination with one another as well as individually. Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method of manufacturing a smart ring with a waterproof design, the method comprising steps of:
obtaining a band with at least an outer surface and an inner surface, the inner surface including features configured to support electronic components;
subsequent to including the electronic components within the inner surface, laser etching a portion of the inner surface; and
subsequent to the laser etching of the portion, applying an epoxy over the electronic components and over the laser etched portion of the inner surface, wherein the laser etched portion includes an increased contact area for bonding with the epoxy for the waterproof design.

2. The method of claim 1, wherein the steps further include:
prior to the laser etching, forming an edge rib on the portion of the inner surface, wherein the laser etching is subsequently on the edge rib.

3. The method of claim 2, wherein the edge rib physically extends outward from the inner surface in a same direction as the electronic components.

4. The method of claim 1, wherein the steps further include:
prior to the laser etching, obtaining the band with the inner surface including an edge rib on the portion of the inner surface, wherein the laser etching is subsequently on the edge rib.

5. The method of claim 4, wherein the edge rib physically extends outward from the inner surface in a same direction as the electronic components.

6. The method of claim 1, wherein the waterproof design is at least 5 atm.

7. The method of claim 1, wherein the steps further include:
prior to the laser etching, applying tape and/or glue to the inner surface of the band to connect the electronic components that include at least a battery and a Flexible Printed Circuit (FPC) thereto.

8. The method of claim 7, wherein the portion extends at least as high as the FPC.

9. The method of claim 1, wherein the electronic components include a plurality of a battery, a Flexible Printed Circuit (FPC), a Near Field Communication (NFC) device, and an antenna.

10. The method of claim 1, wherein the steps further include:
forming the band via machining including using a Computer Numerical Control (CNC) technique and/or a Computer-Aided Manufacturing (CAM) technique.

11. A smart ring with a waterproof design, formed by a process comprising steps of:
obtaining a band with at least an outer surface and an inner surface, the inner surface including features configured to support electronic components;
subsequent to including the electronic components within the inner surface, laser etching a portion of the inner surface; and
subsequent to the laser etching of the portion, applying an epoxy over the electronic components and over the laser etched portion of the inner surface, wherein the laser etched portion includes an increased contact area for bonding with the epoxy for the waterproof design.

12. The smart ring of claim 11, wherein the steps further include:
prior to the laser etching, forming an edge rib on the portion of the inner surface, wherein the laser etching is subsequently on the edge rib.

13. The smart ring of claim 12, wherein the edge rib physically extends outward from the inner surface in a same direction as the electronic components.

14. The smart ring of claim 11, wherein the steps further include:
prior to the laser etching, obtaining the band with the inner surface including an edge rib on the portion of the inner surface, wherein the laser etching is subsequently on the edge rib.

15. The smart ring of claim 14, wherein the edge rib physically extends outward from the inner surface in a same direction as the electronic components.

16. The smart ring of claim 11, wherein the waterproof design is at least 5 atm.

17. The smart ring of claim 11, wherein the steps further include:
prior to the laser etching, applying tape and/or glue to the inner surface of the band to connect the electronic components that include at least a battery and a Flexible Printed Circuit (FPC) thereto.

18. The smart ring of claim 17, wherein the portion extends at least as high as the FPC.

19. The smart ring of claim 11, wherein the electronic components include a plurality of a battery, a Flexible Printed Circuit (FPC), a Near Field Communication (NFC) device, and an antenna.

20. The smart ring of claim 11, wherein the steps further include:
forming the band via machining including using a Computer Numerical Control (CNC) technique and/or a Computer-Aided Manufacturing (CAM) technique.
